(19) United States
(12) Patent Application Publication
(10) Pub. No.: US 2003/0185159 A1
(43) Pub. Date: Oct. 2, 2003

(54) Apparatus and method for determining pilot signal field position information for uplink power control in an HSDPA mobile communication system

(75) Inventors: Myeong-Sook Seo, Suwon-shi (KR); Sung-Ho Choi, Songnam-shi (KR); Ju-Ho Lee, Suwon-shi (KR); Yong-Jun Kwak, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/395,619

(22) Filed: Mar. 24, 2003

(30) Foreign Application Priority Data
Mar. 23, 2002 (KR) 15918/2002

(51) Int. Cl. H04B 7/005

(52) U.S. Cl. 370/278; 370/345

(57) ABSTRACT

A mobile communication system transmits a control channel having an ACK/NACK information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control. A radio network controller (RNC), connected to the Node and the neighbor Node B, identifies a plurality of UEs including the particular UE and other UEs, all of which are located in the handover region and receive the high speed packet data, and transmits pilot signal field position information to the UEs so that pilot signal fields that must be transmitted by the particular UE and the other UEs should not overlap with one another in the CQI field. The particular UE includes a pilot signal in a control channel at a position based on its own pilot signal field position information, and transmits the control channel.

### PRIORITY

This application claims priority under 35 U.S.C. § 119 to an application entitled “Apparatus and Method for Determining Pilot Signal Field Position Information for Uplink Power Control in an HSDPA Mobile Communication System” filed in the Korean Industrial Property Office on Mar. 23, 2002 and assigned Serial No. 2002-15918, the contents of which are incorporated herein by reference.

### BACKGROUND OF THE INVENTION

1. Field of the Invention

The present invention relates generally to an uplink transmission power control apparatus and method in a code division multiple access (CDMA) mobile communication system, and in particular, to an apparatus and method for providing a user element (UE) with position information of a pilot signal field on an uplink control channel for high speed downlink packet access (HSDPA).

2. Description of the Related Art

Mobile communication systems have developed from an early mobile communication system that chiefly provides a voice service into an advanced mobile communication system that supports high-speed, high-quality radio data packet communication for providing a data service and a multimedia service. Standardization for a high-speed, high-quality radio data packet service has been conducted on a 3^{rd} generation mobile communication system divided into a synchronous system, also known as a 3GPP (3^{rd} Generation Partnership Project) system, and an asynchronous system, also known as a 3GPP2 (3^{rd} Generation Partnership Project 2) system. Actually, 3GPP has being carrying out standardization on high speed downlink packet access (HSDPA), while 3GPP2 has been conducting standardization on 1xEV-DV (Evolution Data and Voice). Such standardization has been actively conducted to find a solution for a high-speed, high-quality radio data packet service of over 2 Mbps in a 3^{rd} generation mobile communication system. Further, a 4^{th} generation mobile communication system is also discussed to provide a high-speed, high-quality multimedia service of a much higher data rate.

Generally, HSDPA refers to a technique for transmitting control information and packet data over a high speed dedicated shared channel (HS-DSCH), a downlink channel for supporting high-speed packet data transmission, in an asynchronous UMTS (Universal Mobile Telecommunications System) mobile communication system. In HSDPA, an advanced technique for increasing adaptability to the variation in channel environments is required in addition to the general techniques provided in the existing mobile communication system. For HSDPA, adaptive modulation and coding (AMC), hybrid automatic retransmission request (HARQ), and fast cell select (FCS) have been proposed to support high-speed packet transmission.

AMC refers to a data transmission technique for adaptively determining a modulation scheme and a coding scheme according to a channel condition between a particular Node B and a user element (UE), thereby improving overall utilization efficiency of the Node B. Therefore, in order to support AMC, a plurality of modulation schemes and coding schemes are required, and a data channel signal is modulated and coded by a combination of the modulation schemes and coding schemes. Each combination of the modulation schemes and the coding schemes is referred to as “modulation and coding scheme (MCS)”, and a plurality of MCSs of a level #1 to a level #n can be defined according to the type of the MCS. That is, AMC is a technique for improving overall system efficiency of a Node B by adaptively determining an MCS level according to a channel condition with the Node B currently wirelessly connected to the UE.

Now, n-channel stop and wait hybrid automatic retransmission request (n-channel SAW HARQ), typically HARQ, will be described. For HARQ, the following two proposals have been provided in order to increase transmission efficiency of automatic retransmission request (ARQ). As a first proposal, HARQ exchanges retransmission requests and responses between a UE and a Node B. As a second proposal, HARQ temporarily stores defective data and then combines the defective data with its retransmitted data. Further, in order to make up for the defects of conventional stop and wait automatic retransmission request (SAW ARQ), HSDPA has introduced n-channel SAW HARQ. In SAW ARQ, next packet data is not transmitted until an acknowledgement signal (ACK) for previous packet data is received. Therefore, in some cases, a UE or a Node B must wait for ACK even though it can currently transmit packet data. However, in n-channel SAW HARQ, a UE or a Node B can continuously transmit packet data even before the ACK for previous packet data is received, thereby increasing channel efficiency. That is, n logical channels are set up between a UE and a Node B. Then, if logical channels can be identified by time or a channel number, a UE receiving packet data can determine a channel over which the packet data is received. In addition, the UE can reconfigure the packet data in the right order or soft-combine the corresponding packet data.

In FCS, if a UE supporting HSDPA is located in a cell overlapping region, or a handover region, a cell having the best channel condition is selected from a plurality of cells. Specifically, if a UE supporting HSDPA enters a cell overlapping region between a current Node B and a new Node B, the UE sets up radio links to a plurality of cells, or Node Bs. A set of the cells to which the UE sets up radio links is referred to as “active set.” The UE receives HSDPA packet data only from a cell having the best channel condition among the cells included in the active set, thereby reducing overall interference. Herein, the cell having the best channel condition will be referred to as “best cell.” For this, the UE must periodically monitor channel conditions of the cells included in the active set, thereby to determine whether there is any cell having a better channel condition than the current best cell. If there is any cell having a better channel condition, the UE transmits a best cell indicator to the cells belonging to the active set. The best cell indicator, an indicator for requesting change from the current best cell to a new best cell, includes an identifier of the new best cell. Each cell in the active set receives the best cell indicator and analyzes a cell identifier included in the received best cell indicator. That is, each cell in the active set determines whether a cell identifier included in the best cell indicator is identical to its own cell identifier. If the cell identifiers are identical to each other, the corresponding cell selected as a new best cell transmits packet data to the UE over HS-DSCH.

FIG. 1 schematically illustrates a downlink channel structure of a conventional mobile communication system supporting HSDPA (hereinafter referred to as an “HSDPA mobile communication system”) and the timing relationship between channels. Referring to FIG. 1, a downlink dedicated physical channel (hereinafter referred to as “DL_DPCH”) is comprised of fields defined in Release-99, the standard for an existing CDMA mobile communication system. FIG. 2 illustrates a detailed structure of one particular slot among three slots constituting the DL_DPCH, wherein downlink control information and data are transmitted over the slot. Describing the fields illustrated in FIG. 2, Data1 and Data2 fields transmit data for supporting operation of an upper layer or data for supporting a dedicated service such as a voice service. A TPC (Transmit Power Control command) field transmits a downlink transmission power control command for controlling transmission power of a UE. A TFCI (Transmitted Format Combination Indicator) field transmits a data rate of the Data1 and Data2 fields, a channel configuration type, and information necessary for channel demodulation. A Pilot field, containing a predetermined symbol stream, is used by a UE to estimate a state of a downlink channel.

In FIG. 1, a high speed physical downlink shared channel (hereinafter referred to as “HS-PDSCH”) is used to transmit HSDPA packet data from a Node B to a UE. The Node B assigns an orthogonal variable spreading factor (OVSF) code having a considerably low spreading factor (SF) to the HS-PDSCH over which high-speed packet data must be transmitted. For example, an SF=16 OVSF code can be assigned to the HS-PDSCH.

Information for controlling the HS-PDSCH is transmitted over a high speed shared control channel (hereinafter referred to as “HS-SCCH”). HS-PDSCH control information transmitted over the HS-SCCH includes:

(1) Transport format and resource related information (hereinafter referred to as “TFRI”): this represents an MCS level to be used in HS-PDSCH, channelization code information of HS-PDSCH, a size of a transport block, and an identifier of a transport channel.

(2) HARQ information:

(a) HARQ process number: in n-channel SAW HARQ, this indicates a particular channel for transmitting packet data among n logical channels for HARQ.

(b) Repetition version: each time a Node B transmits HSDPA packet data to a UE, the Node B transmits a selected part of the HSDPA packet data. Therefore, the UE must know a repetition version in order to determine which part was transmitted.

(c) New-data indicator: this indicates whether HSDPA packet data transmitted from a Node B to a UE is new packet data or retransmitted packet data.

As stated above, the HS-SCCH can be divided into a TFRI part and an HARQ information part. The TFRI information is information needed to despread the HS-PDSCH over which HSDPA packet data is transmitted. That is, a UE, if it does not have the TFRI information, cannot despread the HS-PDSCH. Therefore, the TFRI information is transmitted at the head of the HS-SCCH, and the HARQ information is transmitted at the end of the HS-SCCH.

The HS-SCCH can be assigned at least one channelization code. In FIG. 1, the number of HS-SCCHs that can be assigned to each UE is, for example, 4. Therefore, a Node B must inform a particular UE which of the 4 HS-SCCHs is assigned thereto. For this, the Node B scrambles the TFRI information part, a first part of the HS-SCCH, with a UE identifier (ID). The UE ID is an identifier uniquely assigned to each UE by the Node B for identification of the UE. The UE then descrambles TFRI information parts of received HS-SCCHs with its own unique UE ID, thereby determining an HS-SCCH assigned thereto.

Next, a process of receiving by the UE an HSDPA service using the above-stated three channels of DL_DPCH, HS-SCCH, and HS-PDSCH will be described herein below.

As illustrated in FIG. 1, DL_DPCH and HS-SCCHs are almost simultaneously transmitted to a UE. Therefore, the UE will despread all of the 4 HS-SCCHs until it determines an HS-SCCH assigned thereto. That is, the UE descrambles a TFRI part of each HS-SCCH with its own unique UE ID, thereby determining an HS-SCCH assigned thereto. If a particular HS-SCCH is an HS-SCCH assigned thereto, the UE decodes the corresponding HS-SCCH. However, if a particular HS-SCCH is not an HS-SCCH assigned thereto, the UE discards values acquired by despreading the corresponding HS-SCCH. After extracting the TFRI information by decoding the HS-SCCH, the UE receives HS-PDSCH and then despreads the received HS-PDSCH. In FIG. 1, the reason that a start point of a transmission time interval (hereinafter referred to as “TTI”) of HS-PDSCH falls two slots behind a start point of TTI of HS-SCCH is to enable the UE to first extract the TFRI information from the HS-SCCH. Finally, the UE demodulates and decodes a signal transmitted over the corresponding HS-PDSCH based on control information detected from the HS-SCCH, thereby detecting HSDPA packet data.

A method for forming an uplink control channel supporting HSDPA will also be proposed. There is a method of modifying an existing uplink dedicated physical control channel (UL_DPCCH) that does not support HSDPA, in order to support HSDPA. However, the existing UL_DPCCH, when modified, may have an incompatibility problem with the existing system and may become very complicated in structure. For these reasons, there has been proposed another method of newly defining an uplink control channel for supporting HSDPA with a new channelization code. Such a method is available because uplink channelization code resources are, so sufficient that every UE can be assigned OVSF codes.

FIG. 3 illustrates a method of newly defining an uplink control channel for supporting HSDPA with a new channelization code. The method of FIG. 3 assigns separate channelization codes to an uplink dedicated physical data channel (hereinafter referred to as “UL_DPDCH”) and an uplink dedicated physical control channel (hereinafter referred to as “UL_DPCCH”), both supporting Release-99, and a high speed uplink dedicated physical control channel (hereinafter referred to as “HS-DPCCH”) for supporting HSDPA.

Referring to FIG. 3, each of slots constituting one frame of the UL_DPDCH for supporting Release-99 transmits upper layer data from a UE to a Node B. Each of slots constituting one frame of the UL_DPCCH is comprised of a Pilot signal field, a TFCI bit field, a feedback information (hereinafter referred to as “FBI”) field, and a TPC field. The Pilot signal field is used as a channel estimation signal when demodulating data transmitted from a UE to a Node B. The TFCI bit field indicates a transmitted format combination of the channels transmitted for a current transmission frame. The FBI field transmits feedback information when a transmission diversity technique is used. The TPC field is used for controlling transmission power of a downlink channel. The UL_DPCCH is spread with an OVSF code before being transmitted, and a spreading factor (SF) used for the OVSF code is fixed to 256.

In HSDPA, a UE determines whether data transmitted from a Node B is defective, and then transmits an acknowledgement signal (hereinafter referred to as “ACK”) or a negative acknowledgement signal (hereinafter referred to as “NACK”) as its result over the HS-DPCCH. Also, in order to support AMC, a UE can transmit channel quality report information to a Node B. The channel quality report information is called a channel quality indicator (hereinafter referred to as “CQI”). In FIG. 3, the HS-DPCCH also transmits a Pilot signal field (HS-Pilot) for HSDPA in addition to the ACK/NACK and the CQI information.

FIG. 4 illustrates transmission of downlink control information and downlink data, and transmission of uplink control information and uplink data for HSDPA. It is assumed herein that a UE is located in a cell (hereinafter referred to as “Node B”) overlapping region, and the number of Node Bs is limited to 2, for the convenience of explanation. In FIG. 4, a Node B#1 401 transmits HS-PDSCH to a UE 411, and a Node B#2 403 transmits DL_DPCH to the UE 411 and receives UL_DPCCH from the UE 411.

In transmitting and receiving the channels described in conjunction with FIGS. 1 and 3, a general power control method used in the existing Release-99 UMTS mobile communication system cannot be used as a power control method in the cell overlapping region. A common power control method in the cell overlapping region will be described with reference to FIG. 4.

Referring to FIG. 4, the Node B#1 401 and the Node B#2 403 receive UL_DPDCH and UL_DPCCH transmitted from the UE 411, and report the receipt to a radio network controller (hereinafter referred to as “RNC”) connected thereto. This is because the RNC analyzes a power control command through the UL_DPDCH and the UL_DPCCH transmitted from the UE 411. If a strength of a signal received from a particular Node B out of the Node B#1 401 and the Node B#2 403 exceeds a threshold value, the RNC transmits a power-down command for decreasing uplink transmission power of the UE 411 to the corresponding Node B whose signal strength exceeds the threshold value. This is to suppress interference within the Node B due to excessive transmission power of the UE 411. Therefore, the UE 411 simultaneously receives DL_DPCHs transmitted from the Node B#1 401 and the Node B#2 403. As described above, for power control between a particular Node B supporting HSDPA and the UE 411, HS-PDSCH, HS-SCCH, and DL_DPCH are transmitted in a downlink direction, and HS-DPCCH, UL_DPDCH, and UL_DPCCH are transmitted in an uplink direction.

UL_DPDCH and UL_DPCCH transmitted from the UE 411 to the Node B#1 401 and the Node B#2 403 are analyzed by the RNC. If the UE 411 currently located in the cell overlapping region communicates with any one of the Node Bs, the UE 411 generally transmits the uplink channels at transmission power lower than normal uplink transmission power. However, HS-DPCCH is information necessary only for the Node B#1 401 that transmits HSDPA packet data, and is not received at the Node B#2 403. Therefore, if the HS-DPCCH is transmitted to the Node B#1 401 at the transmission power applied to the UL_DPDCH and the UL_DPCCH, the Node B#1 401 may fail to correctly analyze HS-DPCCH which is needed to transmit HSDPA packet data. That is, if the HS-DPCCH information is not correctly transmitted to the Node B#1 401, an operation of determining an HARQ type and an MCS level or selecting the best cell in FCS cannot be correctly achieved, causing a malfunction of HSDPA.

Therefore, when the UE 411 receiving HSDPA packet data is located in the soft handover region, transmission power of UL_DPDCH, UL_DPCCH, and HS-DPCCH is separately controlled. For that purpose, the UE 411 transmits an additional HS-Pilot over HS-DPCCH of FIG. 3 so that the Node B should generate a high speed transmission power control (HS-TPC) command for only the HS-DPCCH. Describing the separate power control, the Node B#1 401 generates a TPC command from the Pilot on the DPCCH and an HS-TPC command from the HS-Pilot on the HS-DPCCH every slot. Meanwhile, the Node B#2 403, since it does not provide an HSDPA service, generates only an existing TPC command from the Pilot on the DPCCH. The Node B#1 401 then transmits the generated TPC and HS-TPC commands over a TPC field on the DL_DPCH of FIG. 2 to the UE 411 by time division multiplexing. For example, of the three slots, two slots are used to transmit the existing TPC command and the other one slot is used to transmit the HS-TPC command. As a result, the UE 411 can perform power control on HS-DPCCH based on an HS-TPC command transmitted once every 3 slots from the Node B#1 401, and at the same time, perform power control on UL_DPDCH and UL_DPCCH based on a TPC command transmitted from the Node B#2 403.

In FIG. 3, the ACK/NACK is transmitted over one slot of 3-slot HSDPA TTI of HS-DPCCH, and N-bit HS-Pilot and CQI information are transmitted over the other two slots. When transmission of the ACK/NACK or the CQI information is not required, the UE 411 subjects the ACK/NACK or CQI field to discontinuous transmission (DTX). The HS-Pilot, as described in conjunction with FIG. 4, is intended to improve reliability of HS-DPCCH when the UE 411 is located in a soft handover region. Therefore, although the HS-Pilot can be transmitted every TTI regardless of a situation of a UE, the HS-Pilot can be optionally transmitted only when the UE 411 is located in the soft handover region.

In FIG. 3, a TTI start point of HS-DPCCH is different from slot start points of DPDCH and DPCCH for the following reasons. That is, in the current HSDPA system, a start point of the HS-DPCCH is determined based on a point where a UE receives HS-PDSCH of FIG. 1, whereas start points of the DPDCH and the DPCCH are determined based on a reception point of DL_DPCH. A slot start point of the DL_DPCH is differently set according to a UE. Therefore, slot start points of the DPDCH and the DPCCH are also differently set according to a UE. However, since the HS-PDSCH is shared by all UEs, a TTI start point of the HS-DPCCH will be the same for all UEs.

Because all UEs within Node Bs providing an HSDPA service transmit all of ACK/NACK, HS-Pilot, and CQI information on the HS-DPCCH at the same time, uplink interference among the UEs may be increased. Herein, since the ACK/NACK and the CQI information are transmitted to each UE only when necessary, interference among the UEs may not be considerable. However, since the HS-Pilot must be transmitted by all UEs when the UEs are located in the soft handover region, interference among the UEs may be considerably increased due to coincidence of transmission points of the HS-Pilot. In this case, due to interference among HS-Pilots of UEs, a Node B may fail to correctly perform channel estimation. That is, even though a channel condition between a Node B and a particular UE is good, the Node B may generate an incorrect HS-TPC command, mistakenly determining that the channel condition is poor.

### SUMMARY OF THE INVENTION

It is, therefore, an object of the present invention to provide an apparatus and method for determining pilot signal field position information for uplink power control in a mobile communication system supporting high speed downlink packet access.

It is another object of the present invention to provide an apparatus and method for determining by a Node B pilot signal field position information for user elements (UEs) when separately performing power control on uplink control channels in a mobile communication system supporting high speed downlink packet access.

It is further another object of the present invention to provide an apparatus and method for determining by a radio network controller (RNC) pilot signal field position information for UEs when separately performing power control on uplink control channels in a mobile communication system supporting high speed downlink packet access.

It is yet another object of the present invention to provide a UE transmission apparatus for including a pilot signal in a control channel according to pilot signal field position information by each UE located in a soft handover region and then transmitting the control channel in a mobile communication system supporting high speed downlink packet access.

It is still another object of the present invention to provide a UE reception apparatus for receiving a control channel from each UE located in a soft handover region and then receiving a pilot signal according to pilot signal field position information included in the control channel in a mobile communication system supporting high speed downlink packet access.

In accordance with a first aspect of the present invention, the present invention provides a mobile communication system including a Node B, a particular user element (UE) existing in an area occupied by the Node B, a neighbor Node B being adjacent to the Node B, and a radio network controller (RNC) connected to the Node B and the neighbor Node B, for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control. In the mobile communication system, the RNC identifies a plurality of UEs including the particular UE and other UEs, all of which are located in the handover region and receive the high speed packet data, and transmits pilot signal field position information to the UEs so that pilot signal fields that must be transmitted by the particular UE and the other UEs should not overlap with one another in the CQI field. The particular UE includes a pilot signal in a control channel at a position based on its own pilot signal field position information, and transmits the control channel.

In accordance with a second aspect of the present invention, the present invention provides a mobile communication system including a Node B, a particular user element (UE) existing in an area occupied by the Node B, a neighbor Node B being adjacent to the Node B, and a radio network controller (RNC) connected to the Node B and the neighbor Node B, for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control. In the mobile communication system, the Node B identifies a plurality of UEs including the particular UE and other UEs, all of which are located in the handover region and receive the high speed packet data, and transmits pilot signal field position information to the RNC so that pilot signal fields that must be transmitted by the particular UE and the other UEs should not overlap with one another in the CQI field. The RNC transmits the pilot signal field position information to the particular UE. The particular UE includes a pilot signal in a control channel at a position based the pilot signal field position information, and transmits the control channel.

In accordance with a third aspect of the present invention, the present invention provides a transmission apparatus of a user element (UE) for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control, in a mobile communication system including the Node B, the particular UE existing in an area occupied by the Node B, the neighbor Node B being adjacent to the Node B, and a radio network controller (RNC) connected to the Node B and the neighbor Node B. In the transmission apparatus, a controller generates and controls a pilot signal to be transmitted over the pilot signal field. A multiplexer configures the control channel by multiplexing ACK/NACK information to be transmitted over the ACK/NACK information field, CQI information to be transmitted over the CQI field, and the pilot signal. A pilot signal field position controller controls the multiplexer based on pilot signal field position information provided from the RNC so that the pilot signal field position information should not overlap, within the CQI field, with pilot signal field position information assigned to other UEs which are located in the handover region and receive the high speed packet data.

In accordance with a fourth aspect of the present invention, the present invention provides a reception apparatus of a user element (UE) for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control, in a mobile communication system including the Node B, the particular UE existing in an area occupied by the Node B, the neighbor Node B being adjacent to the Node B, and a radio network controller (RNC) connected to the Node B and the neighbor Node B. In the reception apparatus, a pilot signal field position controller controls a demultiplexer based on pilot signal field position information determined for the particular UE so that the determined pilot signal field position information should not overlap, within the CQI field, with pilot signal field position information assigned to other UEs which are located in the handover region and receive the high speed packet. The demultiplexer extracts the pilot signal field from the control channel under the control of the pilot signal field position controller. A controller generates a transmission power control command (HS-TPC) for power control on the control channel based on a pilot signal included in the pilot signal field.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates downlink channels for a high speed downlink packet access (HSDPA) service;

FIG. 2 illustrates an example of a downlink dedicated physical channel;

FIG. 3 illustrates an example of uplink dedicated physical channels;

FIG. 4 illustrates a situation in which a UE is located in a soft handover region;

FIG. 5 illustrates an exemplary method of variably operating HS-Pilot signal field positions for UEs according to an embodiment of the present invention;

FIG. 6 illustrates another situation in which a UE is located in a soft handover region;

FIG. 7 illustrates a message flow diagram between a radio network controller and a Node B for signaling HS-Pilot signal field position information according to an embodiment of the present invention;

FIG. 8 illustrates a message flow diagram between a radio network controller and a UE for transmitting HS-Pilot signal field position information to the UE according to an embodiment of the present invention;

FIG. 9 illustrates a procedure performed by a UE according to a first embodiment of the present invention;

FIG. 10 illustrates a procedure performed by a radio network controller according to a first embodiment of the present invention;

FIG. 11 illustrates a procedure performed by a Node B according to a first embodiment of the present invention;

FIG. 12 illustrates a procedure performed by a UE according to a second embodiment of the present invention;

FIG. 13 illustrates a procedure performed by a radio network controller according to a second embodiment of the present invention;

FIG. 14 illustrates a procedure performed by a Node B controller according to a second embodiment of the present invention;

FIG. 15 illustrates an example of a UE transmitter according to an embodiment of the present invention;

FIG. 16 illustrates an example of a Node B receiver according to an embodiment of the present invention; and

FIG. 17 illustrates an example of a Node B transmitter according to an embodiment of the present invention.

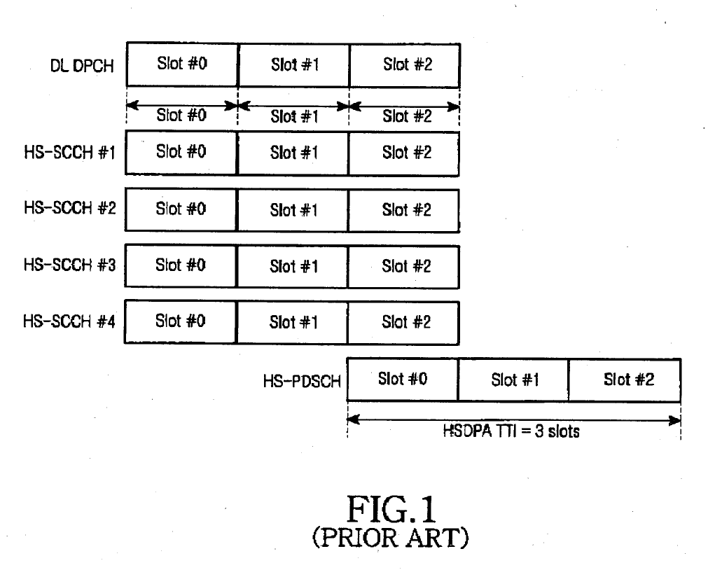

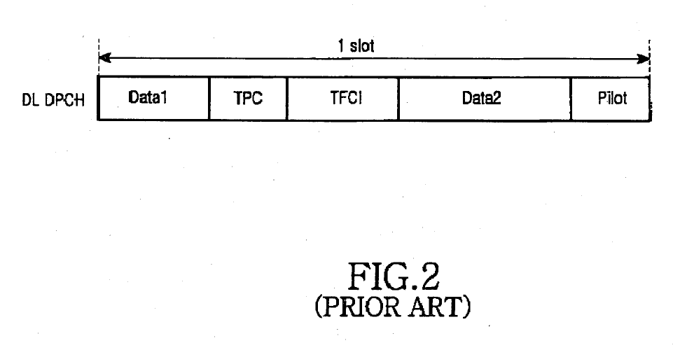

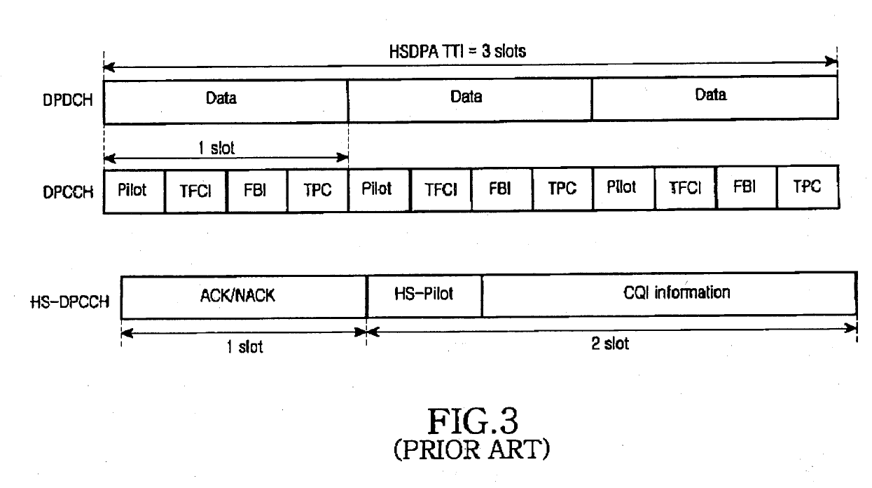

### DETAILED DESCRIPTION OF THE PREFERRED EMBODIMENT

Several preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein has been omitted for conciseness.

Herein, the present invention will be described with reference to a high speed downlink packet access (hereinafter referred to as “HSDPA”) mobile communication system, i.e., an asynchronous 3GPP mobile communication system, for the convenience of explanation. However, the invention can be applied in the same way even to other mobile communication systems that simultaneously control transmission power of two or more uplink channels.

A description will first be made of a method for assigning different pilot signal field position information to each of a plurality of UEs located in a soft handover region in order to achieve the above and other objects of the present invention. In the following description, the pilot signal field position information according to the present invention will be referred to as “pilot symbol offset,” and the pilot signal field newly added according to the present invention will be referred to as “HS-Pilot.”

As described above, because transmission points of HS-Pilots for all UEs within a Node B supporting an HADPA service are conventionally identical to one another, the Node B may perform incorrect channel estimation based on HS-Pilots transmitted over each HS-DPCCH. For these reasons, the present invention proposes a method for variably operating, by the Node B, positions of HS-Pilots according to UEs, thereby preventing transmission points of HS-Pilots from the UEs from overlapping. For convenience of explanation, it will be assumed that a position of the HS-Pilot in the HS-DPCCH falls behind a first slot in TTI, where ACK/NACK information is transmitted. In addition, it will also be assumed that a spreading factor (SF) of the HS-DPCCH is 256. Since the ACK/NACK information is transmitted over one slot, the ACK/NACK information will be comprised of 10 bits. The sum of HS-Pilot bits and CQI information bits, being transmitted over the other two slots, will be 20 bits.

A position of the HS-Pilot according to the present invention can be expressed by an offset on the basis of a start point of a second slot. Alternatively, a position of the HS-Pilot can be determined on the basis of a TTI start point or another particular position. For example, in HS-DPCCH from each UE, if an HS-Pilot offset is 0 bit, the HS-Pilot is transmitted over a part succeeding the ACK/NACK information, i.e., an initial part of a second slot in the TTI. If, however, the HS-Pilot offset is 1 bit, the HS-Pilot is located 1 bit behind a start point of the second slot. In this case, a UE transmits the N-bit HS-Pilot according to the offset, and transmits (20-N)-bit CQI information over a field where the HS-Pilot is not transmitted. The HS-Pilot offset can be represented by the bit as stated above, or a chip or a multiple of the chip. In the following description, the HS-Pilot offset will be referred to as “HS-Pilot position information” of the HS-Pilot field.

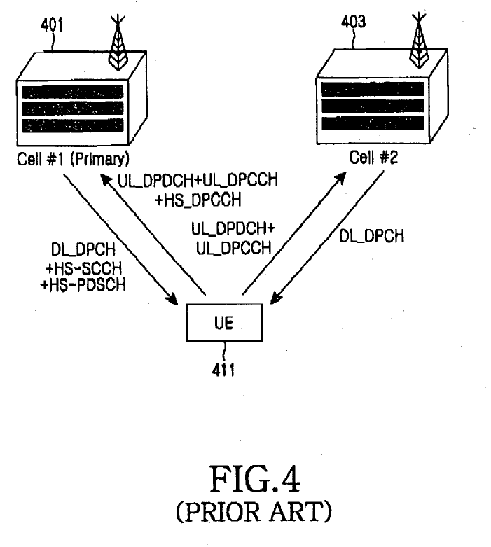

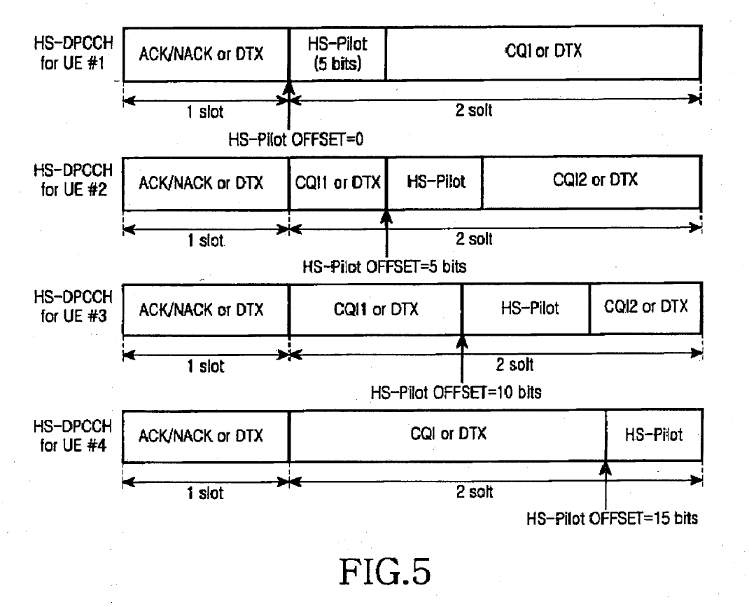

FIG. 5 illustrates examples of a pilot symbol offset that can be assigned to the UE 411 in the situation illustrated in FIG. 4. Specifically, FIG. 5 illustrates an example of a method for assigning a variable HS-Pilot position to a plurality of UEs located in a soft handover region.

In FIG. 5, it is assumed that the number of UEs provided with an HSDPA service from a Node B is 4. As illustrated in FIG. 5, HS-DPCCHs from respective UEs are identical to one another in their TTI start points. Each UE performs discontinuous transmission (DTX) on ACK/NACK and CQI information, when the UE is not required to transmit the ACK/NACK and CQI information to a Node B. In this case, if the number of HS-Pilot bits is 5, the Node B can set an HS-Pilot offset for a UE#1 to 0 bit, an HS-Pilot offset for a UE#2 to 5 bits, an HS-Pilot offset for a UE#3 to 10 bits, and an HS-Pilot offset for a UE#4 to 15 bits, as illustrated in FIG. 5. Therefore, for the UE#2, HS-Pilot starts its transmission 5 bits behind a start point of a second slot, and the remaining part of two succeeding slots is separately used transmit CQI information. For the UE#3, HS-Pilot starts its transmission 10 bits behind the start point of the second slot (i.e., a start point of a third slot), and the remaining part of second and third slots is separately used transmit CQI information. For the UE#4, HS-Pilot starts its transmission 15 bits behind the start point of the second slot, and the remaining part of the second and third slots is separately used transmit CQI information.

As illustrated in FIG. 5, HS-Pilot positions for UEs do not overlap with one another, thus preventing interference to one another, so that a Node B can perform correct channel estimation based on HS-Pilot. To this end, a mobile communication system according to the present invention provides a method for determining an HS-Pilot position for separate power control on HS-DPCCH, and informing a corresponding UE of the determined HS-Pilot position. As a first method, a radio network controller (RNC) determines an HS-Pilot offset and informs a corresponding UE of the determined HS-Pilot offset by signaling. As a second method, a Node B determines an HS-Pilot offset considering UEs being provided with an HSDPA service, and informs a corresponding UE of the determined HS-Pilot offset by signaling.

First Embodiment

In a first embodiment of the present invention, an RNC determines an HS-Pilot offset for uplink power control and informs a corresponding UE of the determined HS-Pilot offset by signaling.

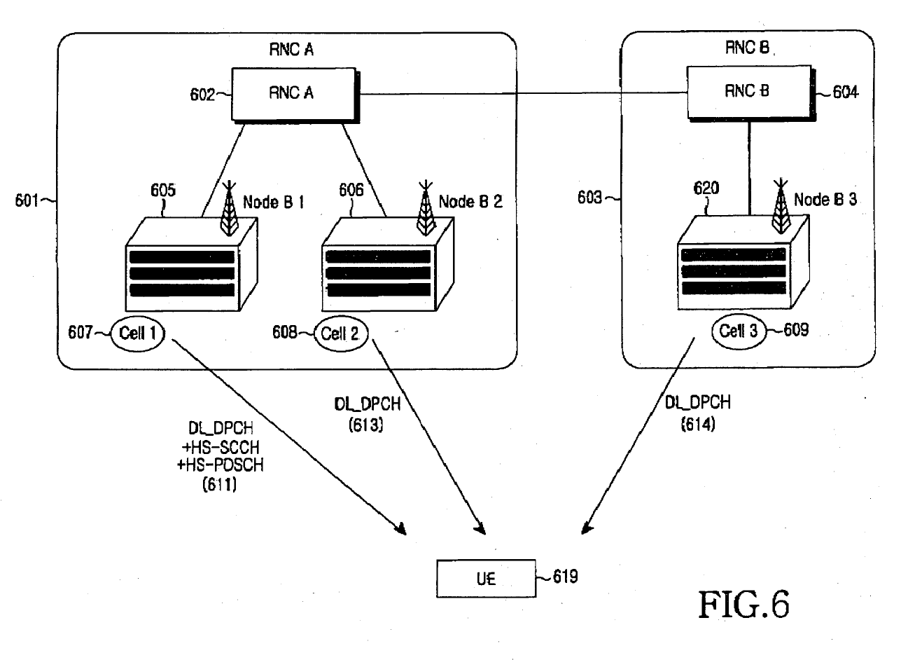

FIG. 6 illustrates an operation between Node Bs and a UE when the UE is in a handover state in a general 3^{rd} generation asynchronous mobile communication system. It is assumed herein that the number of active Node Bs for the UE is 3. Further, it is assumed that a Node B#1 and a Node B#2 belong to the same RNC, and a Node B#3 belongs to another RNC. In the 3^{rd} generation asynchronous mobile communication standard, a radio network system (hereinafter referred to as “RNS”) refers to an RNC and Node Bs controlled by the RNC. An RNS A 601 represents an RNC A 602, and a Node B#1 605 and a Node B#2 606, controlled by the RNC A 602. An RNS B 603 represents an RNC B 604 and a Node B#3 620 controlled by the RNC B 604. It will be assumed in FIG. 6 that the RNC A 602 is a serving RNC (SRNC) and the RNC B 604 is a drift RNC (DRNC). The SRNC refers to an RNC that controls a UE service for a particular UE and manages connection with a core network (hereinafter referred to as “CN”). An RNC, other than an SRNC, included in the RNCs that handle UE data for a particular UE is called “DRNC.”

An operation of a UE 619 belonging to a plurality of active Node Bs will now be described. Although each Node B has a plurality of cells, it will be assumed herein that each Node B has only one cell, for simplicity. For example, the UE 619 may get away from a cell#1 607 within the Node B#1 605 while receiving an HSDPA service from the cell#1 607 over DL_DPCH, HS-SCCH and HS-PDSCH 611. At this moment, the UE 619 transmits DPDCH, DPCCH and HS-DPCCH to the cell#1 607 in an uplink direction. The UE 619 then performs soft handover in which the UE 619 receives a signal from the current cell#1 607 along with a signal from another cell having higher signal strength than a threshold value. The UE 619 continuously monitors signals received from several cells and includes cells having high signal strength in its active set one by one. For example, in FIG. 6, a cell#2 608 within the Node B#2 606 and a cell#3 609 within the Node B#3 620 are included in the active set so that the UE 619 can receive DL_DPCH signals 612 and 613 from the different cells 608 and 609.

When the UE 619 receives an HSDPA service from the cell#1 607, downlink channels transmitted from the cell#1 607 to the UE 619 include DL_DPCH, HS-SCCH for the HSDPA service, and HS-PDSCH. However, other cells 608 and 609 in the active set transmit only DL_DPCH to the UE 619. This is because the HS-PDSCH does not support soft handover. Describing the reasons, HS-PDSCH transmits high-speed data, so that while a particular Node B#1 transmits the high-speed data, another Node B#2 has a difficulty in determining a data packet transmission state of a particular Node B#1 and then immediately transmitting the data packet. Therefore, the UE 619, when it is located in a soft handover region while receiving a HSDPA service, can receive HS-SCCH and HS-PDSCH 611 for the HDPA service only from the cell#1 607, and receive DL_DPCHs, which carries upper layer signaling data or voice data and dedicated physical control information, from the other cells 608 and 609.

The RNC A 602, an SRNC, can determine whether the UE 619 is located in a soft handover region, based on a report from the UE 619. To accomplish this, the UE 619 measures reception power for its neighbor Node B based on a common pilot channel (hereinafter referred to as “CPICH”) received from the Node B. As the UE 619 gets away from the Node B#1 605 and approaches the Node B#2 606, reception power measured from CPICH of the Node B#1 605 is gradually decreased and reception power measured from CPICH of the Node B#2 606 is gradually increased. If reception power of the Node B#2 606 is higher by a predetermined value than reception power of the Node B#1 605, it is said in wideband code division multiple access (WCDMA) standard that “Event 1A” has occurred. The term “Event 1A” means that a radio link from the Node B#2 606 must be added to an active set.

The UE then sends a Measurement Report message with the measured results to a UMTS terrestrial radio access network (UTRAN) over a radon access channel (hereinafter referred to as “RACH”) in order to inform the UTRAN that the “Event 1A” has occurred. If DPCH is set up for a voice call, the UE may send the Measurement Report message over the DPCH. In the current standard, the RACH is randomly accessed by the UE in an ALOHA (Additive Links Online Hawaii Area) technique. Unlike the DPCH, the RACH has a collision problem, so that in some cases, the Measurement Report message cannot be reliably transmitted. The UE operates the RACH in an acknowledged mode (AM) so as to reliably transmit a Measurement Report message. If the Measurement Report message is not correctly transmitted to the UTRAN over the RACH, the UTRAN sends a retransmission request signal to the UE until it correctly receives the Measurement Report message. In FIG. 6, if a Measurement Report message is correctly received from the UE 619, the Node B#1 605 delivers the received Measurement Report to the RNC A 602. Through this process, the RNC A 602 can determine whether a particular UE is located in a soft handover region.

After the process described above, the UE 619 must transmit HS-Pilot in order to separately perform power control on an uplink HS-DPCCH in a soft handover region. A description will now be made of a method for determining by the RNC A 602 an HS-Pilot offset indicating a position of HS-Pilot in the HS-DPCCH. Actually, the RNC A 602, an SRNC, knows only whether the UE is located in a soft handover region, but does not know whether the UE is being provided with an HSDPA service. This is because the RNC A 602 receives, from the UE, only an “Event 1A” Report message indicating that the UE has entered the soft handover region. Therefore, since the RNC A 602 has no information on a list of UEs receiving the HSDPA service, the RNC A 602 only randomly determines the HS-Pilot offset instead of optimally determining the HS-Pilot offset.

After determining the HS-Pilot offset of HS-DPCCH from the UE 619, the RNC A 602 must inform the Node B#1 605 and the UE 619 of the determined offset. This is because the UE 619 transmits HS-DPCCH in a new type by applying the offset provided from the RNC A 602 and the Node B#1 605 must be able to receive the HS-DPCCH. In the method of transmitting an HS-Pilot offset value from the RNC A 602 to the Node B#1 605, a Node B application part (BAP) message, a signaling message between a Node B and an RNC, is used. As described above, the RNC A 602 to which the Node B#1 605 controlling the HSDPA service belongs is herein defined as an SRNC, for the convenience of explanation. In this case, the RNC A 602, an SRNC, can transmit an HS-Pilot offset to the Node B#1 605 through only the NBAP message. If the RNC A 602 to which the Node B#1 605 belongs is a DRNC and the RNC B 604 is an SRNC, the RNC B 604 must inform the RNC A 602 of the HS-Pilot offset using a radio network subsystem application part (RNSAP) message, a signaling message between RNCs. The RNC A 602 then informs the Node B#1 605 again of the HS-Pilot offset using the NBAP message. In the embodiment of the present invention, a signaling message will be described considering only the case where the RNC A 602 serves as an SRNC.

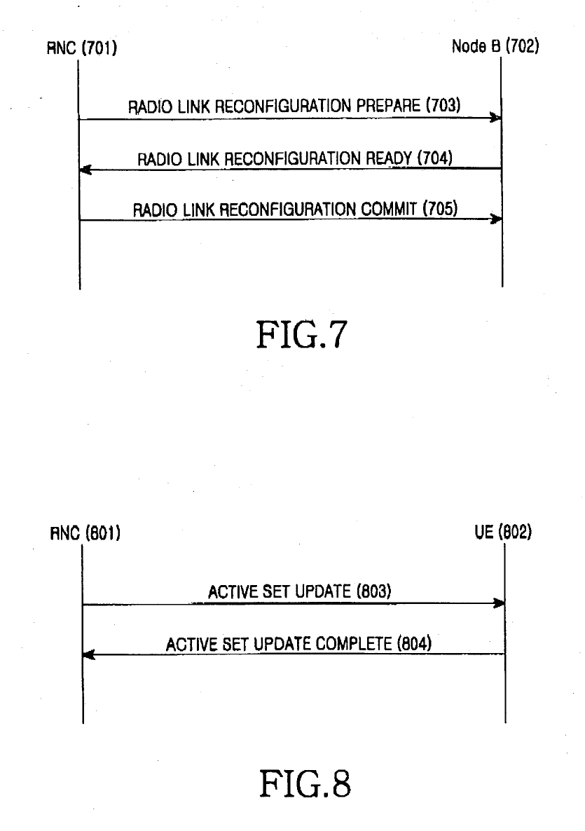

A Radio Link Reconfiguration Prepare message can be used as an NBAP message for transmitting an HS-Pilot offset from the RNC A 602 to the Node B#1 605. In addition to the Radio Link Reconfiguration Prepare message, an RNC can use other messages capable of changing a characteristic of a physical channel for controlling a Node B. Since a channel condition before the UE 619 is located in the soft handover region is different from a channel condition after the UE 619 moves to the soft handover region, the HS-DPCCH is reestablished. This will be described in more detail with reference to FIG. 7.

FIG. 7 illustrates a process of exchanging NBAP messages between an RNC A 602, an SRNC, and a Node B#1 605, wherein the RNC A 602 instructs the Node B#1 605 to prepare for reconfiguration of channel resources and then exchanges reconfigured channels after receiving a response. Referring to FIG. 7, an RNC 701 corresponding to the RNC A 602 transmits a Radio Link Reconfiguration Prepare message 703 to a Node B 702 corresponding to the Node B#1 605. In this process, the RNC 701 orders the Node B 702 to prepare for channel reestablishment according to parameters in the Radio Link Reconfiguration Prepare message 703. After successfully preparing to reestablish corresponding channels, the Node B 702 transmits a Radio Link Reconfiguration Ready message 704. The RNC 701 then transmits a Radio Link Reconfiguration Commit message 705 to the Node B 702 so that the Node B 702 can reestablish channels according to the reconfigured channel resources.

Parameters included in the Radio Link Reconfiguration Prepare message 703 are illustrated in Table 1.

TABLE 1
IE/Group Name

Message Type
UL DPCH Information

> UL Scrambling code
> UL DPCCH Slot Format

UL HS-DPCCH Information

> HS-Pilot position offset

DL DPCH Information

> DL DPCH Slot Format

DCHs to Delete
DSCH to modify
DSCH to Delete
RL Information

>RL ID

As illustrated in Table 1, the parameters included in the Radio Link Reconfiguration Prepare message can be divided into uplink DPCH information, uplink HS-DPCCH information, downlink DPCH information, DCHs to be deleted, DSCH information to be deleted, and DSCH information to be modified. Table 1 shows only the parameters necessary for description of the present invention, for simplicity. Therefore, additional parameters can also be transmitted over the Radio Link Reconfiguration Prepare message. In Table 1, “Message Type” is a parameter indicating that a type of the NBAP message is a Radio Link Reconfiguration Prepare message. The uplink DPCH information may include “UL Scrambling code” representing scrambling code information of an uplink DPCH, and “UL_DPCCH Slot Format” representing a slot format of an uplink DPCCH. The downlink DPCH information may include “DL DPCH Slot Format” representing a slot format of a downlink DPCH. An “RL Information” parameter includes “RL ID” for identifying a radio link between a UTRAN and a UE. The above-stated information represents the parameters previously defined in the conventional 3GPP standard. In addition, as HS-DPCCH information according to the present invention, an “HS-Pilot position offset” parameter for transmitting an HS-Pilot offset determined by the RNC 701 to the Node B 702 can be newly defined as illustrated Table 1.

The RNC can inform the Node B of an HS-Pilot offset by using either the “HS-Pilot position offset” parameter or a TTI format parameter of the HS-DPCCH. Although the “HS-Pilot position offset” parameter is used herein for the convenience of explanation, other parameters can also be used. The HS-Pilot offset is also referred to as “HS-Pilot signal field position information.” For example, the RNC previously defines TTI formats according to the HS-Pilot position, and then informs the Node B of only the TTI format so that the Node B can determine a position of HS-Pilot. TTI formats determined according to HS-Pilot offsets are illustrated in Table 2.

TABLE 2

| HS-DPCCH | | | | | | HS-Pilot |
|---|---|---|---|---|---|---|
| TTI Format # i | SF | Bits/TTI | N_{ACK/NACK} | N_{CQ1} | N_{HS-Pilot} | Position offset |
| 0 | 256 | 30 | 10 | 20 | 0 | 0 |
| 1 | 256 | 30 | 10 | 15 | 5 | 0 |
| 2 | 256 | 30 | 10 | 15 | 5 | 5 |
| 3 | 256 | 30 | 10 | 15 | 5 | 10 |
| 4 | 256 | 30 | 10 | 15 | 5 | 15 |

In Table 2, TTI Format#0 represents a TTI format for the case where HS-Pilot is not used, and TTI Format#1 to #4 represent TTI formats for the case where HS-pilot is used. The TTI format represents a spreading factor SF of HS-DPCCH, the number (Bits/TTI) of bits transmitted per TTI, the number N_{ACK/NACK} of ACK/NACK bits, the number N_{CQI} of CQI bits, the number N_{HS-Pilot} of HS-Pilot bits, and a position offset when HS-Pilot is used. ACK/NACK is transmitted in 10 bits over a first slot of TTI, and in the case of TTI where HS-Pilot is not transmitted, CQI information is transmitted 20 bits over the remaining slot. In TTI Format#1 to #4 where HS-Pilot is transmitted, ACK/NACK is transmitted in 10 bits, CQI information is transmitted in 15 bits and HS-Pilot is transmitted in 5 bits. In TTI Format#1 where an HS-Pilot offset is 0, HS-Pilot is transmitted beginning at a start point of the second slot as illustrated in FIG. 5. In TTI Format#2 where an HS-Pilot offset is 1, HS-Pilot is transmitted 5 bits behind the starting point of the second slot as illustrated in FIG. 5.

Upon receiving the Radio Link Reconfiguration Prepare message 703, the Node B 702 prepares for channel resource reconfiguration by consulting the parameters illustrated in Table 2, and then transmits the Radio Link Reconfiguration Ready message 704 to the RNC 701. Parameters included in the Radio Link Reconfiguration Ready message 704 are illustrated in Table 3.

TABLE 3
IE/Group name

Message Type
RL Information Response

> RL ID
> DCH Information Response
> DSCH Information Response

The parameters included in the Radio Link Reconfiguration Ready message 704 includes Message Type indicating a type of a particular NBAP message, and RL Information Response indicating a response for a particular radio link. Information included in the RL Information Response includes “RL ID” indicating a radio link identifier, a reestablished DCH, DCH Information Response with DSCH information, and DSCH Information Response. Table 3 shows only the parameters necessary for description of the present invention, for simplicity. Therefore, additional parameters can also be transmitted over the Radio Link Reconfiguration Ready message 704.

Upon receiving the Radio Link Reconfiguration Ready message 704 from the Node B 702, the RNC 701 informs the Node B 702 of an activation time through the Radio Link Reconfiguration Commit message 705 so that the Node B 702 can transmit or receive a reestablished channel. The activation time according to the present invention indicates when the Node B 702 starts receiving HS-DPCCH with HS-Pilot determined based on an HS-Pilot offset from a UE located in a soft handover region. Parameters included in the Radio Link Reconfiguration Commit message 705 are illustrated in Table 4.

TABLE 4
IE/Group Name

Message Type
CFN

In Table 4, Message Type is a parameter indicating a type of a particular NBAP message, and CFN (Connection Frame Number) is a parameter indicating a start point where the Node B starts transmitting and receiving the channels reestablished according to the parameters of Table 1. The CFN is an absolute value representing the number of frames counted by the Node B after a radio link is set up. Table 4 shows only the parameters necessary for description of the present invention, for simplicity. Therefore, additional parameters can also be transmitted over the Radio Link Reconfiguration Commit message 705.

In the method of transmitting HS-Pilot offset information from an SRNC to a UE according to the present invention, a radio resource control (RRC) signaling message, i.e., a signaling message between a UE and an RNC, is used. FIG. 8 illustrates a process of exchanging an Active Set Update message 803 and an Active Set Update Complete message 804, being an RRC signaling message between an RNC and a UE, in order to signal an HS-Pilot offset according to the present invention from the RNC A 602 to the UE 619. In addition to the Active Set Update message, the RNC can also use other messages that can change a characteristic of a physical channel for controlling a UE. For example, the other messages may include a Physical Channel Reconfiguration message, a Transport Channel Reconfiguration message, and a Radio Bearer Reconfiguration message. The present invention will be described with reference to the Active Set Update message for the convenience of explanation.

Table 5 below illustrates an example of the Active Set Update message 803 transmitted from an RNC 801 corresponding to the RNC A 602 to a UE 802 corresponding to the UE 619. First, an Activation Time message, which represents an absolute time when the UE 802 starts transmitting and receiving a radio link that is added or deleted, is transmitted as information necessary for a UE. When a radio link is added, i.e., when the UE 619, as it moves to the Node B 606, is handed over to the Node B 606, the RNC A 602 transmits information on each downlink to the UE 619. A message transmitted to the UE 619 includes “Primary CPICH info” being CPICH information of the Node B#2 609, and “Downlink DPCH info for each RL” being DPCH information for each radio link. Each time an active set is updated, the RNC 801 informs the UE 802 of a resource for an uplink channel, and for this, a “Maximum allowed UL Tx power” message indicating maximum uplink transmission power is used.

That is, when the UE 802 is located in a soft handover region as stated above, the RNC 801 transmits an HS-Pilot position offset message to the UE 802 through the Active Set Update message 803. The UE 802 then inserts HS-Pilot in HS-DPCCH according to the HS-Pilot offset as described in conjunction with FIG. 5, and then transmits the HS-DPCCH to a Node B at an activation time indicated by the Activation Time message. Absolute time indicated by CFN of Table 4, indicating a time point where the Node B 605 starts transmitting and receiving the reestablished channels, should coincide with the activation time. Although Table 5 shows only the messages necessary for description of the present invention for simplicity, additional messages can also be transmitted over the Active Set Update message 803 when necessary.

TABLE 5
ACTIVE SET UPDATE

UE Information Elements

>Activation Time

Downlink Radio resources

>Radio link addition Information

>>Primary CPICH info
>>Downlink DPCH info for each RL

Uplink Radio Resources

>Maximum allowed UL TX Power
>HS-Pilot Position Offset

After the process described above, if the Active Set Update message 803 of Table 5 is received and successfully handled, the UE 802 transmits an Active Set Update Complete message 804 to the RNC 801.

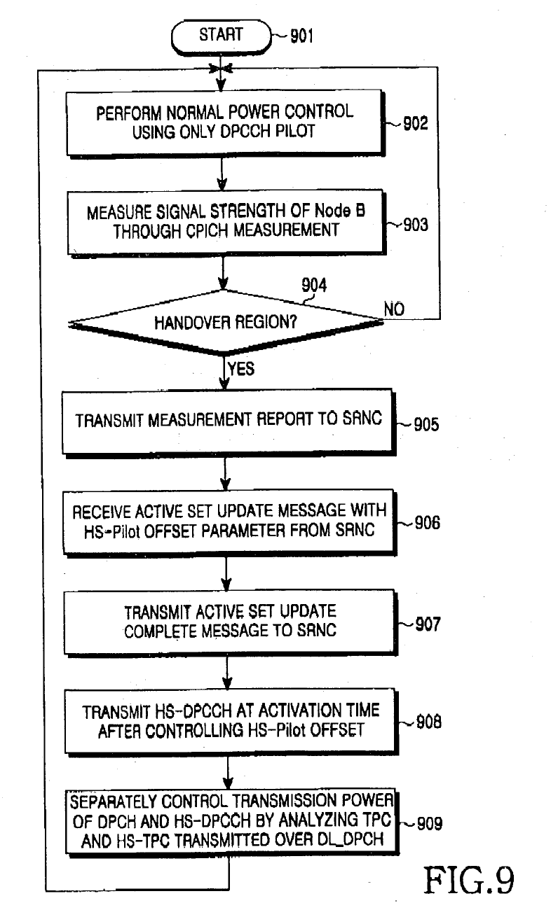

FIG. 9 illustrates an algorithm for a UE controller according to a first embodiment of the present invention. Referring to FIG. 9, a UE 619 performs power control on HS-DPCCH, UL_DPCCH, and UL_DPDCH depending on a pilot signal on DPCCH in step 902. In step 903, the UE 619 measures reception power of CPICHs from several Node Bs. If reception power of a Node B#1 605 is higher by a predetermined value than reception power of a Node B#2 606, “Event 1A” occurs. The occurrence of Event 1A means that the UE 619 is located in a soft handover region. In step 904, the UE 619 determines whether Event 1A has occurred, i.e., whether it is located in a soft handover region. If it is determined that the UE 619 is located in a soft handover region, the UE 619 includes the Node B#2 606 in its active set, and then transmits a Measurement Report message with the measured results to an RNC A 602, an SRNC, in step 905. If, however, it is determined in step 904 that Event 1A has not occurred, the UE 619 returns to step 902.

If a UTRAN completes update of an active set after the UE 619 completely transmits the Measurement Report message to the SRNC 602 in step 905, the SRNC 602 transmits an Active Set Update message with an HS-Pilot offset parameter to the UE 619. The Active Set Update message can use the parameters illustrated in Table 5. Upon receiving the Active Set Update message in step 906, the UE 619 transmits an Active Set Update Complete message in step 907 in response to the received Active Set Update message. In step 908, the UE 619 inserts HS-Pilot in an uplink HS-DPCCH according to the HS-Pilot offset and then transmits the uplink HS-DPCCH at an activation time indicated by the Activation Time parameter included in the Active Set Update message of Table 5. A Node B generates HS-TPC from HS-Pilot in the HS-DPCCH, generates TPC from Pilot in the UL_DPCCH, TDM-multiplexes the HS-TPC and the TPC, and then transmits the TDM-multiplexed value over DL_DPCH. For example, the TPC is transmitted over TPC fields on two slots among three slots of the DL_DPCH, and the HS-TPC is transmitted over a TPC field on the other one slot. In step 909, after the activation time, the UE 619 separately analyzes TPC and HS-TPC transmitted over DL_DPDCH, controls power of UL_DPCCH and UL_DPDCH based on TPC, and controls power of HS-DPCCH based on HS-TPC. Thereafter, the UE 619 returns to step 902.

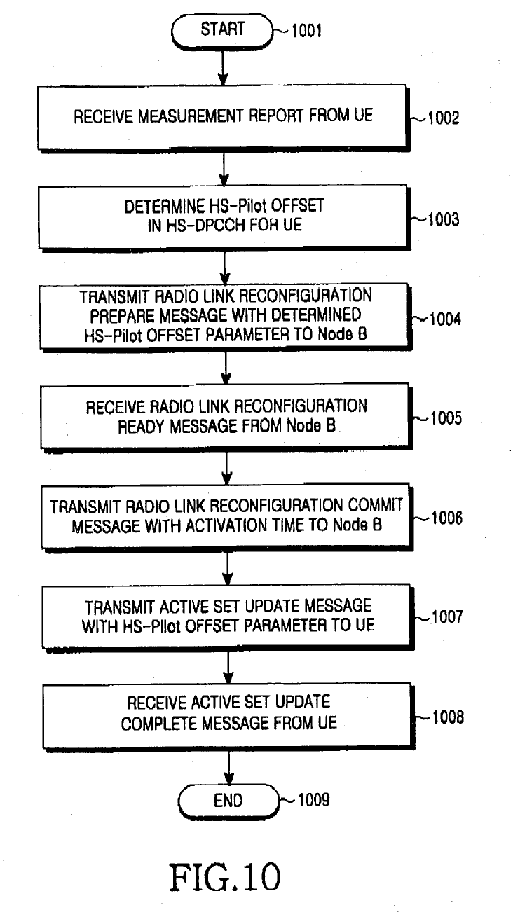

FIG. 10 illustrates an algorithm for an SRNC controller according to a first embodiment of the present invention. Referring to FIG. 10, an RNC A 602, an SRNC, receives a Measurement Report message from a UE in step 1002. In step 1003, the SRNC perceives that the UE is located in a soft handover region, and randomly determines an HS-Pilot position offset used to separately perform power control on HS-DPCCH. In step 1004, the SRNC includes the HS-Pilot offset parameter in a Radio Link Reconfiguration Prepare message and transmits the Radio Link Reconfiguration Prepare message to a Node B#1 in order to transmit the determined HS-Pilot offset to the Node B#1. The Node B#1 then reconfigures a channel resource according to the Radio Link Reconfiguration Prepare message received, and prepares to receive HS-DPCCH based on the HS-Pilot. Thereafter, the Node B#1 transmits a Radio Link Reconfiguration Ready message to the SRNC in response to the Radio Link Reconfiguration Prepare message. In step 1005, the SRNC receives the Radio Link Reconfiguration Ready message from the Node B#1 and perceives that a channel resource has been normally reconfigured. In step 1006, the SRNC transmits to the Node B#1 a Radio Link Reconfiguration Commit message with a CFC parameter indicating a time point where transmission and reception of the reconfigured channels are started. In step 1007, the SRNC transmits to the UE an Active Set Update message with an Activation Time parameter indicating a time point where transmission of HS-DPCCH is started according to the determined HS-Pilot offset information and the offset value. After completion of updating an active set, the UE transmits an Active Set Update Complete message to the SRNC in response to the Active Set Update message. In step 1008, the SRNC receives-the Active Set Update Complete message from the UE, and ends the algorithm in step 1009.

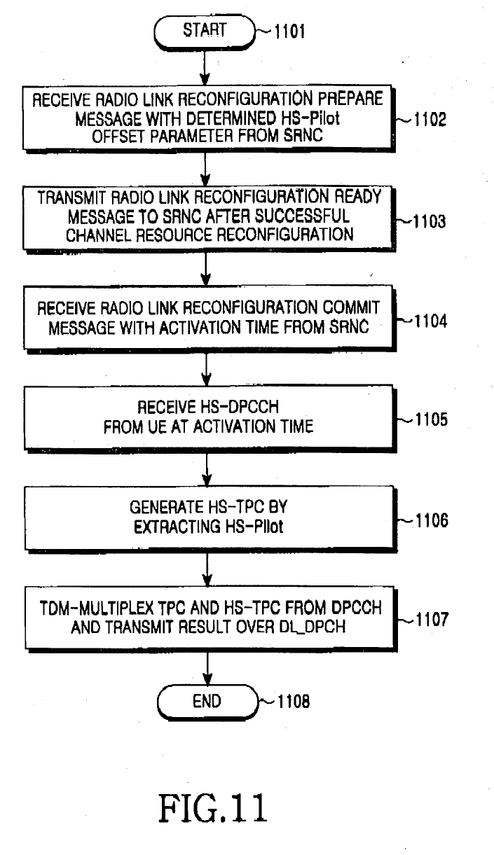

FIG. 11 illustrates an algorithm for a Node B controller according to a first embodiment of the present invention. Referring to FIG. 11, a Node B#1 605 receives, from an SRNC, a Radio Link Reconfiguration Prepare message with an HS-Pilot offset determined by the SRNC in step 1102. After reconfiguring a channel resource according to the received Radio Link Reconfiguration Prepare message, the Node B#1 transmits to the SRNC a Radio Link Reconfiguration Ready message in response to the Radio Link Reconfiguration Prepare message in step 1103. In step 1104, the Node B#1 receives, from the SRNC, a Radio Link Reconfiguration Commit message with a CFN parameter indicating a time point where the transmission and reception of the reestablished channels are started. In step 1105, the Node B#1 receives HS-DPCCH proposed by the present invention from a UE based on the CFN. Since the Node B#1 already has HS-Pilot offset information provided from the SRNC, in step 1106, the Node B#1 performs, channel estimation by extracting HS-Pilot from HS-DPCCH received from the UE 619, and then generates HS-TPC, a power control command for HS-DPCCH. In step 1107, the Node B#1 generates HS-TPC from the HS-Pilot on the HS-DPCCH, generates TPC from the Pilot in the DPCCH, TDM-multiplexes the HS-TPC and the TPC, and then transmits the TDM-multiplexed value over DL_DPCCH. Thereafter, the Node B#1 ends the algorithm in step 1108. For example, the TPC is transmitted over TPC fields on two slots among three slots of the DL_DPCCH, and the HS-TPC is transmitted over a TPC field on the other one slot.

To summarize, in the first embodiment an RNC randomly determines an HS-Pilot offset for each UE, since the RNC does not know a list of UEs receiving an HSDPA service.

Second Embodiment

In a second embodiment of the present invention, a Node B determines an HS-Pilot offset considering UEs receiving an HSDPA service, and then transmits the determined HS-Pilot offset to a particular UE.

If an HS-Pilot offset is randomly determined by an RNC as described above, positions of uplink HS-Pilots from UEs cannot be optimally dispersed. In order to solve this problem, in the second embodiment, a Node B determines an HS-Pilot offset for each UE receiving an HSDPA service. In this embodiment, upon receiving, from an SRNC, information indicating that a UE is located in a soft handover region, a Node B maximally disperses an HS-Pilot position for the UE. For this, the Node B can determine offsets so that HS-Pilot positions for UEs should not overlap with one anther as described in conjunction with FIG. 5.

The Node B#1 605 can determine whether a UE is located in a soft handover region, based on a signaling message from an SRNC. An RNC A 602, the SRNC, can determine whether the UE is located in the soft handover region, based on a report from the UE, as described in conjunction with the first embodiment. Describing this process, a UE continuously measures reception power for its neighbor Node Bs based on CPICH from the Node Bs. As the UE gets away from a Node B#1 605 and approaches a Node B#2 606, reception power measured from CPICH of the Node B#1 605 is gradually decreased and reception power measured from CPICH of the Node B#2 606 is gradually increased. If reception power of the Node B#2 606 is higher by a predetermined value than reception power of the Node B#1 605, it is said in the WCDMA standard that “Event 1A” has occurred. The term “Event 1A” means that a radio link from the Node B#2 606 must be added to an active set.

The UE then sends a Measurement Report message with the measured results to a UTRAN over an RACH in order to inform the UTRAN that the “Event 1A” has occurred. If DPCH is set up for a voice call, the UE may send the Measurement Report message over the DPCH. In the current standard, the RACH is randomly accessed by the UE in the ALOHA technique. Unlike the DPCH, the RACH has a collision problem, so that in some cases, the Measurement Report message cannot be reliably transmitted. The UE operates the RACH in an acknowledged mode (AM) so as to reliably transmit a Measurement Report message. If the Measurement Report message is not correctly transmitted to the UTRAN over the RACH, the UTRAN sends a retransmission request signal to the UE until it correctly receives the Measurement Report message. In FIG. 6, if a Measurement Report message is correctly received from the UE 619, the Node B#1 605 delivers the received Measurement Report to the RNC A 602. Through this process, the RNC A 602 can determine whether a particular UE is located in a soft handover region.

After the process stated above, the RNC A 602 must inform the Node B#1 605 that the UE is located in a soft handover region so that the Node B#1 605 can determine an HS-Pilot offset. In the method where the RNC A 602 transmits to the Node B#1 605 an NBAP message, a signaling message between a Node B and an RNC, in order to inform the Node B#1 605 that the UE is located in a handover region, a Radio Link Reconfiguration Prepare message can be used as an NBAP message used by the RNC A 602 to inform the Node B#1 605 that the UE is located in a soft handover region. In addition to the Radio Link Reconfiguration Prepare message, an RNC can use other messages capable of changing a characteristic of a physical channel for controlling a Node B. In the HSDPA system, the Radio Link Reconfiguration Prepare message is required to reestablish a previously established channel when the UE 619 is located in a soft handover region.

With reference to FIG. 7, a description will be made of a process of exchanging NBAP messages between an RNC A 602, an SRNC, and a Node B#1 605, wherein the RNC. A 602 instructs the Node B#1 605 to prepare for reconfiguration of channel resources and then exchanges reconfigured channels after receiving a response. Referring to FIG. 7, an RNC 701 corresponding to the RNC A 602 transmits a Radio Link Reconfiguration Prepare message 703 to a Node B 702 corresponding to the Node B#1 605. In this process, the RNC 701 orders the Node B 702 to prepare for channel reestablishment according to parameters in the Radio Link Reconfiguration Prepare message 703. After successfully preparing to reestablish corresponding channels, the Node B 702 transmits a Radio Link Reconfiguration Ready message 704. The RNC 701 then transmits a Radio Link Reconfiguration Commit message 705 to the Node B 702 so that the Node B 702 can reestablish channels according to the reconfigured channel resources.

Parameters included in the Radio Link Reconfiguration Prepare message 703 are illustrated in Table 6.

TABLE 6
IE/Group Name

Message Type
UL DPCH Information

> UL Scrambling code
> UL DPCCH Slot Format

DL DPCH Information

>DL DPCH Slot Format

DCHs to Delete
DSCH to modify
DSCH to Delete
RL Information

>RL ID

As illustrated in Table 6 , the parameters included in the Radio Link Reconfiguration Prepare message can be divided into uplink DPCH information, downlink DPCH information, DCHs to be deleted, DSCH information to be deleted, and DSCH information to be modified. Table 6 shows only the parameters necessary for description of the present invention, for simplicity. Therefore, additional parameters can also be transmitted over the Radio Link Reconfiguration Prepare message. In Table 6 , “Message Type” is a parameter indicating that a type of the NBAP message is a Radio Link Reconfiguration Prepare message. The uplink DPCH information may include “UL Scrambling code” representing scrambling code information of an uplink DPCH, and “UL_DPCCH Slot Format” representing a slot format of an uplink DPCCH. The downlink DPCH information may include “DL DPCH Slot Format” representing a slot format of a downlink DPCH. An “RL Information” parameter includes “RL ID” for identifying a radio link between a UTRAN and a UE. There are as many RL Information parameters as the number of radio links. For example, if the number of radio links is 2, the number of RL Information parameters is also 2. This means that the UE has two radio links, i.e., indicates that the UE is located in a soft handover region. Therefore, if the RNC A 602 provides the Node B#1 605 with the RL Information parameter, the Node B#1 605 can determine whether the UE is located in a soft handover region, based on the number of RL Information parameters. That is, the RNC 701 can inform the Node B 702 whether the UE is located in a soft handover region, without using additional parameters of the Radio Link Reconfiguration Prepare message. The RNC 701 can inform the Node B 702 whether the UE is located in a soft handover region, by either using the RL Information parameter or adding a new Handover Indication parameter to the Radio Link Reconfiguration Prepare message.

After determining whether the UE is located in a soft handover region based on the received Radio Link Reconfiguration Prepare message 703, the Node B 702 determines an offset depending on HS-Pilot positions 6f UEs within the Node B 702 itself so that HS-Pilot for the UE should not overlap with other HS-Pilots. Thereafter, the Node B 702 transmits the determined HS-Pilot offset to the RNC 701 along with a Radio Link Reconfiguration Ready message 704. Parameters included in the Radio Link Reconfiguration Ready message 704 are illustrated in Table 7.

TABLE 7
IE/Group name

Message Type
HS-Pilot Position Offset
RL Information Response

> RL ID
> DCH Information Response
> DSCH Information Response

The parameters included in the Radio Link Reconfiguration Ready message 704 includes Message Type indicating a type of a particular NBAP message, and RL Information Response indicating a response for a particular radio link. Information included in the RL Information Response includes “RL ID” indicating a radio link identifier, a reestablished DCH, DCH Information Response with DSCH information, and DSCH Information Response. In addition, an HS-Pilot position offset parameter for transmitting an HS-Pilot offset determined by the Node B 702 to the RNC 701 can be newly defined as illustrated in Table 7. The above-stated information represents the parameters previously defined in the conventional 3GPP standard. Table 7 shows only the parameters necessary for description of the present invention, for simplicity. Therefore, additional parameters can also be transmitted over the Radio Link Reconfiguration Ready message 704.

The RNC 701 can inform the Node B 702 of an HS-Pilot offset with either the HS-Pilot position offset parameter or a TTI format parameter of HS-DPCCH. Although the present invention will be described on the assumption that the HS-Pilot position offset parameter is used for the convenience of explanation, a different parameter can also be used. For example, the RNC 701 previously defines TTI formats according to the HS-Pilot position, and then informs the Node B 702 of only the TTI format so that the Node B 702 can determine a position of HS-Pilot. TTI formats determined according to HS-Pilot offsets are illustrated in Table 8.

TABLE 8

| HS-DPCCH | | | | | | HS-Pilot |
|---|---|---|---|---|---|---|
| TTI Format # i | SF | Bits/TTI | N_{ACK/NACK} | N_{CQ1} | N_{HS-Pilot} | Position offset |
| 0 | 256 | 30 | 10 | 20 | 0 | 0 |
| 1 | 256 | 30 | 10 | 15 | 5 | 0 |
| 2 | 256 | 30 | 10 | 15 | 5 | 5 |
| 3 | 256 | 30 | 10 | 15 | 5 | 10 |
| 4 | 256 | 30 | 10 | 15 | 5 | 15 |

Upon receiving the Radio Link Reconfiguration Ready message 704 from the Node B 702, the RNC 701 informs the Node B 702 of activation time through a Radio Link Reconfiguration Commit message 705 so that the Node B 702 can transmit or receive a reestablished channel. The activation time according to the present invention indicates when the Node B 702 starts receiving HS-DPCCH with HS-Pilot determined based on an HS-Pilot offset from a UE located in a soft handover region. Parameters included in the Radio Link Reconfiguration Commit message 705 are illustrated in Table 9 below

TABLE 9
IE/Group Name

Message Type
CFN

In Table 9, Message Type is a parameter indicating a type of a particular NBAP message, and CFN is a parameter indicating a start point where the Node B starts transmitting and receiving the channels reestablished according to the parameters of Table 9. The CFN is an absolute value representing the number of frames counted by the Node B after a radio link is set up. Table 9 shows only the parameters necessary for description of the present invention, for simplicity. Therefore, additional parameters can also be transmitted over the Radio Link Reconfiguration Commit message 705.

In the method of transmitting HS-Pilot offset information from an SRNC to a UE according to the present invention, an RRC signaling message, a signaling message between a UE and an RNC, is used. FIG. 8 illustrates a process of exchanging an Active Set Update message 803 and an Active Set Update Complete message 804, being RRC signaling messages between an RNC and a UE, in order to signal an HS-Pilot offset according to the present invention from an RNC 801 to a UE 802. In addition to the Active Set Update message, the RNC can also use other messages that can change a characteristic of a physical channel controlled by a Node B. For example, the other messages may include a Physical Channel Reconfiguration message, a Transport Channel Reconfiguration message, and a Radio Bearer Reconfiguration message. The present invention will be described with reference to the Active Set Update message for the convenience of explanation.

Table 10 below illustrates an example of the Active Set Update message 803 transmitted from the RNC 801 to the UE 802. First, an Activation Time message representing an absolute time when the UE 802 starts transmitting and receiving a radio link that is added or deleted, is transmitted as information necessary for a UE. When a radio link is added, i.e., when the UE 619, as it moves to the Node B 606, is handed over to the Node B 606, the RNC A 602 transmits information on each downlink to the UE 619. A message transmitted to the UE 619 includes “Primary CPICH info” being CPICH information of the Node B#2 609, and “Downlink DPCH info for each RL” being DPCH information for each radio link. Each time an active set is updated, the RNC 801 informs the UE 802 of a resource for an uplink channel, and for this, a “Maximum allowed UL Tx power” message indicating maximum uplink transmission power is used.

In addition, the RNC 801 can also transmit to the UE 802 an HS-Pilot position offset message for transmitting an HS-Pilot position in the HS-DPCCH according to the present invention. When the UE 802 is located in a soft handover region, the RNC 801 transmits an HS-Pilot position offset message to the UE 802 along with the Active Set Update message 803. The UE 802 then inserts HS-Pilot in HS-DPCCH according to the HS-Pilot offset as described in conjunction with FIG. 5, and then transmits the HS-DPCCH to a Node B at activation time indicated by the Activation Time message. Absolute time indicated by CFN of Table 9 , indicating a time point where the Node B 605 starts transmitting and receiving the reestablished channels, should coincide with the activation time.

TABLE 10
ACTIVE SET UPDATE

UE Information Elements

>Activation Time

Downlink Radio resources

>Radio link addition Information

>>Primary CPICH info
>>Downlink DPCH info for each RL

Uplink Radio Resources

>Maximum allowed UL TX Power
>HS-Pilot Position Offset

Although Table 10 shows only the messages necessary for description of the present invention for simplicity, additional messages can also be transmitted over the Active Set Update message 803 when necessary.

After the process described above, if the Active Set Update message 803 of Table 10 is received and successfully handled, the UE 802 transmits an Active Set Update Complete message 804 to the RNC 801.

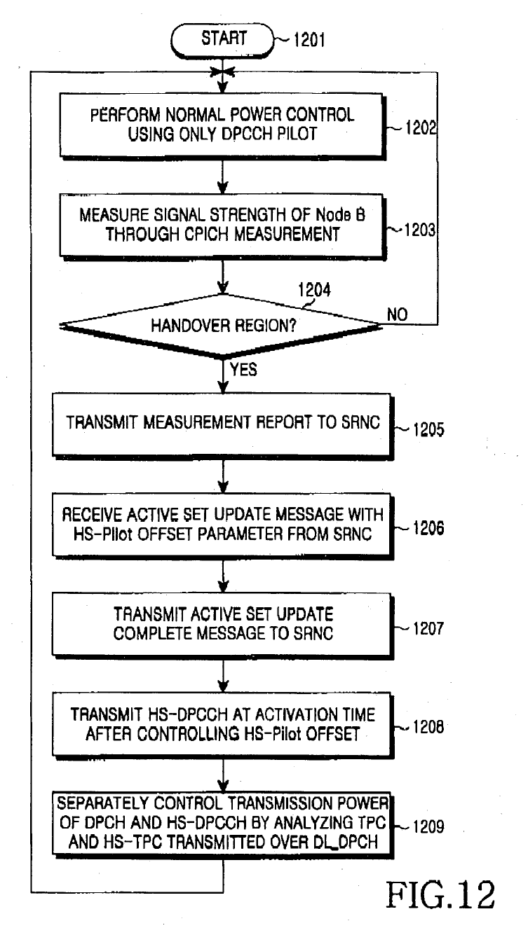

FIG. 12 illustrates an algorithm for a UE controller according to a second embodiment of the present invention. Referring to FIG. 12, a UE 619 performs power control on HS-DPCCH, UL_DPCCH, and UL_DPDCH depending on a pilot signal on DPCCH in step 1202. In step 1203, the UE 619 measures reception power of CPICHs from several Node Bs. If reception power of a Node B#1 605 is higher by a predetermined value than reception power of a Node B#2 606, “Event 1A” occurs. The occurrence of Event 1A means that the UE 619 is located in a soft handover region. In step 1204, the UE 619 determines whether Event 1A has occurred, i.e., whether it is located in a soft handover region. If it is determined that the UE 619 is located in a soft handover region, the UE 619 includes the Node B#2 606 in its active set, and then transmits a Measurement Report message with the measured results to an RNC A 602, an SRNC, in step 1205. If, however, it is determined in step 1204 that Event 1A has not occurred, the UE 619 returns to step 1202.

If a UTRAN completes update of an active set after the UE 619 transmits the Measurement Report message to the SRNC 602 in step 1205, the SRNC 602 transmits an Active Set Update message with an HS-Pilot offset parameter to the UE 619. The Active Set Update message can use the parameters illustrated in Table 10 . Upon receiving the Active Set Update message in step 1206, the UE 619 transmits an Active Set Update Complete message in step 1207. In step 1208, the UE 619 inserts an HS-Pilot in an uplink HS-DPCCH according to the HS-Pilot offset and then transmits the uplink HS-DPCCH at an activation time indicated by the Activation Time parameter included in the Active Set Update message of Table 5. A Node B generates HS-TPC from the HS-Pilot in the HS-DPCCH, generates TPC from the Pilot in the UL_DPCCH, TDM-multiplexes the HS-TPC and the TPC, and then transmits the TDM-multiplexed value over DL_DPCH. For example, the TPC is transmitted over TPC fields on two slots among three slots of the DL_DPCH, and the HS-TPC is transmitted over a TPC field on the other one slot. After the activation time, in step 1209, the UE 619 separately analyzes TPC and HS-TPC transmitted over DL_DPDCH, controls power of UL_DPCCH and UL_DPDCH based on TPC, and controls power of HS-DPCCH based on HS-TPC. Thereafter, the UE 619 returns to step 1202.

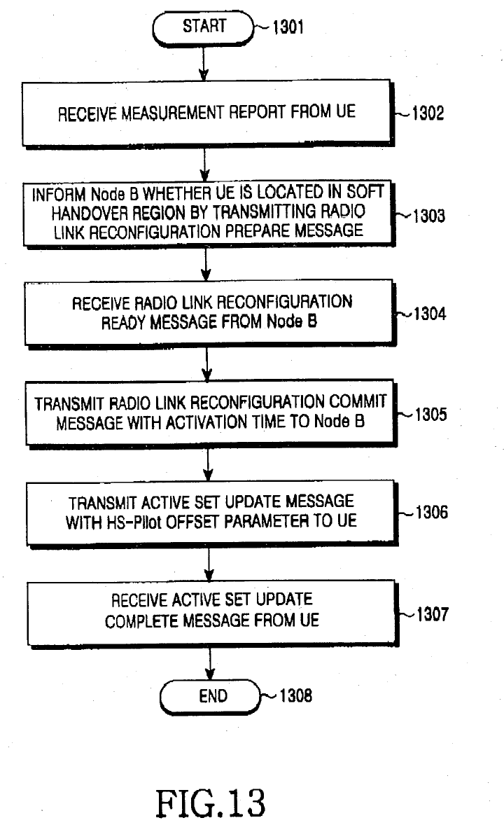

FIG. 13 illustrates an algorithm for an SRNC controller according to a second embodiment of the present invention. Referring to FIG. 13, RNC A 602, an SRNC, receives a Measurement Report message from a UE in step 1302. In step 1303, the SRNC perceives that the UE is located in a soft handover region and transmits a Radio Link Reconfiguration Prepare message to a Node B#1 605 in order to inform the Node B#1 605 that the UE is located in a soft handover region. Upon receiving the Radio Link Reconfiguration Prepare message, the Node B reconfigures a channel resource and determines the HS-Pilot. In this case, the Node B determines an HS-Pilot offset for the UE in such a way that HS-Pilot positions for all UEs should be dispersed as described in conjunction with FIG. 5. The Node B then transmits a Radio Link Reconfiguration Ready message to the SRNC along with the determined HS-Pilot offset parameter illustrated in Table 7 , in response to the Radio Link Reconfiguration Prepare message. In step 1304, the SRNC receives a Radio Link Reconfiguration Ready message from the Node B, perceives that a channel resource has been normally configured, and determines an HS-Pilot offset. In step 1305, the SRNC transmits to the Node B a Radio Link Reconfiguration Commit message with a CFC parameter indicating a time point where transmission and reception of the reconfigured channels are started. In step 1306, the SRNC transmits to the UE an Active Set Update message with an Activation Time parameter indicating a time point where transmission of HS-DPCCH is started according to the determined HS-Pilot offset information and the offset value. Thereafter, if the Active Set Update message is normally received, the UE transmits an Active Set Update Complete message to the SRNC in response thereto. In step 1307, the SRNC receives the Active Set Update Complete message from the UE, and then ends the algorithm in step 1309.

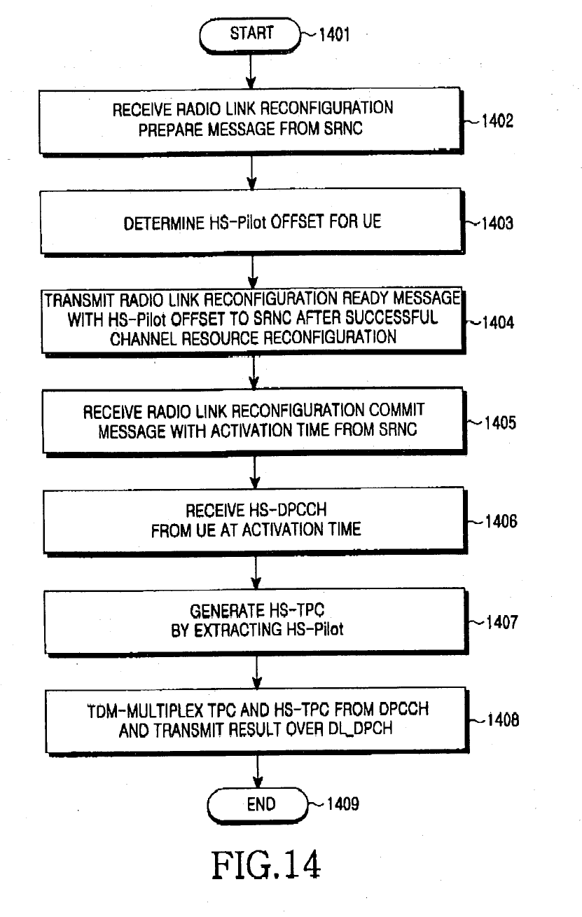

FIG. 14 illustrates an algorithm for a Node B controller according to a second embodiment of the present invention. Referring to FIG. 14, in step 1402, a Node B#1 605 receives a Radio Link Reconfiguration Prepare message from an SRNC, and perceives that a UE is located in a soft handover region. In step 1403, the Node B#1 605 determines an HS-Pilot offset for the UE in such a way that HS-Pilot positions for all UEs should be dispersed as described in conjunction with FIG. 5. In step 1404, the Node B#1 605 reconfigures a channel resource according to the Radio Link Reconfiguration Prepare message, and then transmits a Radio Link Reconfiguration Ready message to the SRNC in response to the Radio Link Reconfiguration Prepare message. The Radio Link Reconfiguration Ready message includes an HS-Pilot offset parameter determined by the Node B. In step 1405, the Node B#1 605 receives a Radio Link Reconfiguration Commit message with a CFN parameter indicating a time point where the transmission and reception of the reestablished channels are started. In step 1406, the Node B#1 605 receives HS-DPCCH proposed by the present invention from a UE based on the CFN. Since the Node B#1 already has HS-Pilot offset information provided from the SRNC, in step 1407, the Node B#1 performs channel estimation by extracting HS-Pilot from HS-DPCCH received from the UE 619, and then generates HS-TPC, a power control command for HS-DPCCH. In step 1408, the Node B#1 generates HS-TPC from the HS-Pilot on the HS-DPCCH, generates TPC from the Pilot on the DPCCH, TDM-multiplexes the HS-TPC and the TPC, and then transmits the TDM-multiplexed value over DL_DPCCH. Thereafter, the Node B#1 ends the algorithm in step 1409. For example, the TPC is transmitted over TPC fields on two slots among three slots of the DL_DPCCH, and the HS-TPC is transmitted over a TPC field on the other one slot.

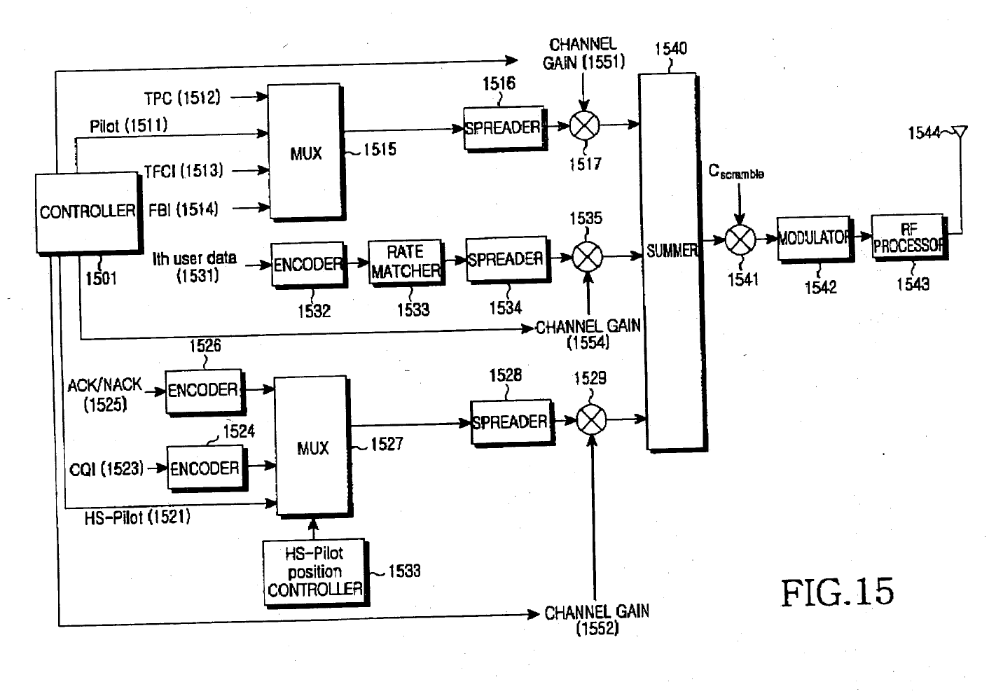

FIG. 15 illustrates an example of a UE transmitter according to an embodiment of the present invention. Referring to FIG. 15, a controller 1501 generates and controls a channel gain 1551 applied to an uplink DPCCH, a channel gain 1554 applied to an uplink DPDCH, a Pilot 1511 applied to the uplink DPCCH, a channel gain 1552 applied to HS-DPCCH, and an HS-Pilot 1521 applied to the HS-DPCCH. The controller 1501 receives several TPCs transmitted from a Node B, and generates the channel gains 1552, 1551 and 1554 based on TPC for HS-DPCCH, HS-TPC, and TPCs for DPDCH and DPCCH. The channel gain 1552 can be directly determined using HS-TPC received from a Node B that transmits HSDPA packet data. Alternatively, if a channel gain to which the received HS-TPC is to be applied is so high that strength of an interference signal for another signal generated by HS-DPCCH in a cell overlapping region is too high, then the channel gain may be set to a specific threshold value. The specific threshold value can be defined as either a relative transmission power ratio or an absolute transmission power level for DPDCH or DPCCH. The relative transmission power ratio or the absolute transmission power level for DPDCH or DPCCH can be transmitted from a Node B to a UE using an upper layer signaling message or a physical layer signal, or can become a value previously agreed between the Node B and the UE.

A multiplexer (MUX) 1515 configures DPCCH by receiving TPC 1512 for downlink power control, a first Pilot 1511 output from the controller 1501, TFCI 1513, and an FBI 1514. The DPCCH output from the multiplexer 1515 is spread with a channelization code for DPCCH by a spreader 1516, multiplied by the channel gain 1551 by a multiplier 1517, and then provided to a summer 1540.

User data 1531, or upper layer signaling information, is encoded with a proper code by an encoder 1532, and then handled by a rate matcher 1533 so that it should be suitable to a transmission format of a physical channel. A signal output from the rate matcher 1533 is spread into DPDCH by a spreader 1534, multiplied by the channel gain 1554 for DPDCH by a multiplier 1535, and then provided to the summer 1540. The channel gain 1554 applied to the multiplier 1535 can be determined by a difference between a data rate of DPCCH and a data rate of DPDCH with respect to the channel gain 1551 applied to the multiplier 1517.

A multiplexer 1527 configures HS-DPCCH by receiving a value acquired by encoding ACK/NACK 1525, control information for n-channel HARQ, by an encoder 1526, a value acquired by encoding CQI information 1523 by an encoder 1524, and an HS-Pilot 1521 determined by the controller 1501. The HS-Pilot 1521 may use the same pattern as the Pilot 1511, or a different pattern from the Pilot 1511.

The UE according to the present invention previously knows a position offset value of HS-Pilot transmitted from a Node B through upper layer signaling message. The offset value, as described above, can be included in an Active Set Update message, an RRC signaling message between an RNC and a UE. The HS-Pilot position offset of the UE is used to control the HS-Pilot position so that it should not overlap with HS-Pilot positions for other UEs. In the present invention, the offset can be determined by either an RNC or a Node B. An HS-Pilot position controller 1553 applies an HS-Pilot offset provided from an upper layer to the HS-DPCCH configured by the multiplexer 1527. The HS-DPCCH output from the multiplexer 1527, to which the HS-Pilot offset is applied, has the format illustrated in FIG. 5.

The summer 1540 sums up input uplink signals and provides its output to a multiplier 1541. Since the uplink signals summed by the summer 1540 are multiplied by different channelization codes for identification, a Node B receiving the summed signals can restore desired signals. The multiplier 1541 scrambles the uplink signals with a unique scrambling code for the UE so that the uplink signals can be distinguished from uplink signals from other UEs. Signals output from the multiplier 1541 are modulated by a modulator 1542, converted into a carrier band signal by an RF (Radio Frequency) processor 1543, and then transmitted to a Node B through an antenna 1544.

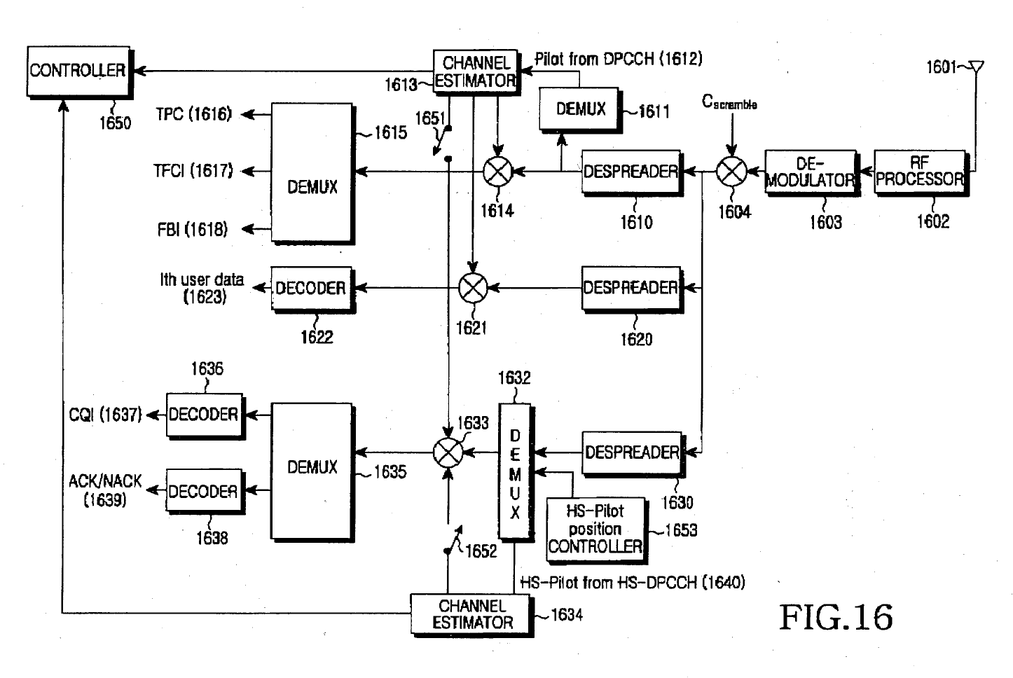

FIG. 16 illustrates an example of a Node B receiver according to an embodiment of the present invention. Referring to FIG. 16, a signal received from a UE through an antenna 1601 is converted to a baseband signal by an RF processor 1602, demodulated by a demodulator 1603, and then descrambled with the scrambling code used in the UE of FIG. 15 by a multiplier 1604. The scrambling code is used by the UE to enable a Node B to distinguish signals received from a plurality of UEs. The UE signal output from the multiplier 1604 is provided in common to despreaders 1610, 1620, and 1630, and separated into DPCCH, DPDCH, and HS-DPCCH. The despreaders 1610, 1620, and 1630 perform a despreading process by multiplying the UE signal from the multiplier 1604 by channelization codes for DPCCH, DPDCH, and HS-DPCCH, respectively. A demultiplexer 1611 extracts only a pilot field 1612 from the DPCCH output from the despreader 1610 and provides the Pilot 1612 to a channel estimator 1613. The Pilot 1612 is used to estimate an uplink channel environment from the UE to the Node B. After estimating strength of the Pilot signal, the Node B generates TPC for power control on uplink DPDCH and DPCCH depending on the strength of the Pilot signal. The DPCCH is multiplied by the channel estimation value from the channel estimator 1613 by a multiplier 1614, for channel compensation, and then demultiplexed into TPC 1616, TFCI 1617, and FBI 1618 by a demultiplexer 1615.

The DPDCH output from the despreader 1620 is multiplied by the channel estimation value from the channel estimator 1613 by a multiplier 1621, for channel compensation, and then decoded into i^{th} user data 1623, or an upper layer signaling message, by a decoder 1622. The decoder 1622 has a rate dematching function as well.

A pilot field is separated from the HS-DPCCH output from the despreader 1630 by a demultiplexer 1632. The demultiplexer 1632 is controlled by an HS-Pilot position controller 1653. The Node B previously knows an offset with which the UE will transmit HS-Pilot. In the first embodiment of the present invention, an RNC informs a Node B of an offset with an NBAP message. In the second embodiment of the present invention, a Node B determines an HS-Pilot offset. If the UE transmits HS-DPCCH according to an HS-Pilot offset as described in conjunction with FIG. 5, the HS-Pilot position controller 1653 of the Node B orders the demultiplexer despreader 1632 to extract HS-Pilot according to the HS-Pilot offset. The HS-Pilot 1640 from the HS-DPCCH is provided to a channel estimator 1634, for channel estimation. A channel estimation value from the channel estimator 1634 is provided to a controller 1650.

The HS-DPCCH channel-compensated by a multiplier 1633 is demultiplexed into ACK/NACK information and CQI information by a demultiplexer 1635, and then decoded into CQI information 1637 and ACK/NACK 1639 by decoder 1636 and 1638, respectively. The decoders 1636 and 1638 have a decoding function corresponding to an encoding and repetition function used by the UE.

The controller 1650 generates a TPC for each channel based on the signal estimation result on a pilot field of DPCCH, estimated by the channel estimator 1613, and the channel estimation result on a pilot field of HS-DPCCH, estimated by the channel estimator 1634. That is, the controller 1650 generates the TPC from the pilot of the DPCCH and the HS-TPC from the HS-Pilot of the HS-DPCCH. The controller 1650 changes a channel estimation value applied to the multiplier 1633 by controlling a switch 1651 connected to the channel estimator 1613 and a switch 1652 connected to the channel estimator 1634 so that channel estimation can be separately performed on the channels to which TPCs are applied. That is, when a signal transmitted based on TPC for the uplink DPCCH is received, the controller 1650 corrects a channel estimation value of HS-DPCCH using a channel estimation value based on a pilot field of DPCCH, and when HS-DPCCH based on the HS-Pilot of the HS-DPCCH is received, the controller 1650 performs channel estimation on HS-DPCCH using a channel estimation value based on the pilot field of the HS-DPCCH.

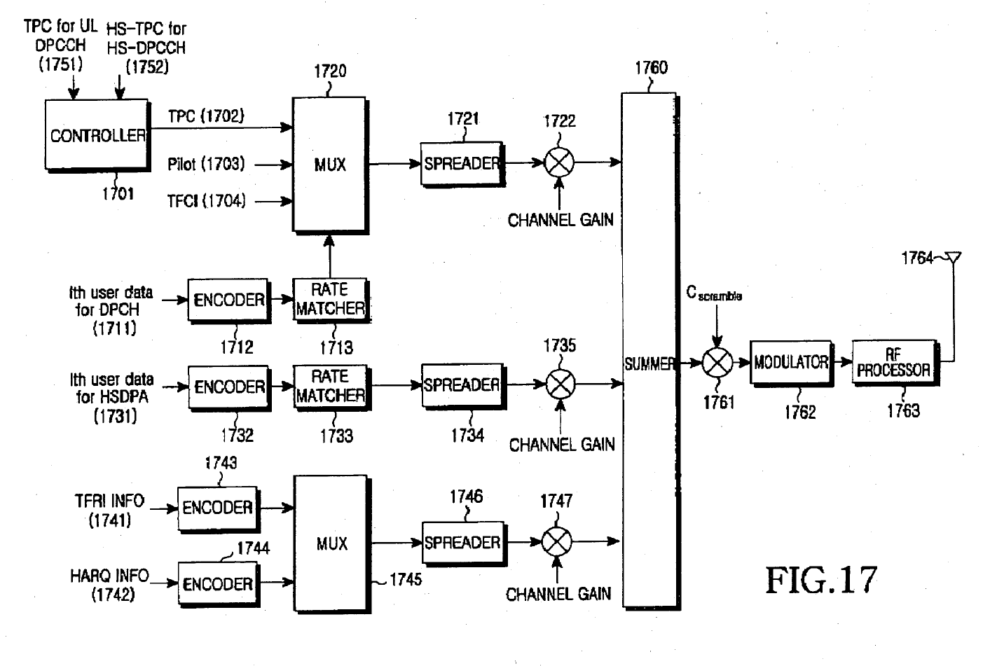

FIG. 17 illustrates an example of a Node B transmitter according to an embodiment of the present invention. Referring to FIG. 17, a controller 1701 provides a multiplexer 1720 with TPC 1751 to be applied to DPCCH and HS-TPC 1752 to be applied to HS-DPCCH, both of which are generated from the controller 1650 of FIG. 16. The controller 1701 can determine transmission points of TPC for DPCCH and HS-TPC for HS-DPCCH considering the following details: (1) data rate, channel condition, signal strength and priority of an uplink DPDCH transmitted by a UE, (2) channel condition and signal strength of HS-DPCCH, and (3) power control ratio of uplink DPCCH to HS-DPCCH and transmission length of HS-DPCCH. For the convenience of explanation, it will be assumed that TPC for the uplink DPCCH is transmitted twice for TTI, and TPC for HS-DPCCH is transmitted once for TTI. As described above, a transmission ratio of TPC for the DPCCH and a transmission ratio of HS-TPC for the HS-DPCCH can be controlled according to circumstances, and the control ratio can be transmitted to the UE through an upper layer signaling message or a physical channel control message, or can be changed by a previous agreement between the Node B and the UE.

The multiplexer 1720 configures DL_DPCCH by receiving TPC 1702, Pilot 1703 and TFCI 1704, and configures DL_DPDCH by receiving a signal generated by convolutional-encoding or turbo-encoding user data 1711;, or upper signaling control information, by an encoder 1712 and then rate-matching the encoded user data by a rate matcher 1713.

DL_DPCH output from the multiplexer 1720 is channel-encoded with a channelization code for DL_DPCH by a spreader 1721, multiplied by a channel gain applied to transmission power of the DL_DPCH by a multiplier 1722, and then summed with other downlink transmission channels by a summer 1760. The channel gain applied to transmission power of the DL_DPCH can be set considering a data rate of DL_DPCH and TPC received over an uplink channel.

Reference numeral 1731 represents i^{th} user data to be transmitted over HS-PDSCH. The i^{th} use data 1731 is encoded by an encoder 1732 using a proper channel encoding method, and then converted by a rate matcher 1733 so that the user data should be suitable to a format of a physical channel. The rate-matched data output from the rate matcher 1733 is channel-coded by a spreader 1734, multiplied by a proper channel gain by a multiplier 1735, and then summed with other downlink channels by the summer 1760. The spreader 1734, as described above, has a plurality of channelization codes, and can increase a data rate of a downlink channel by using several channelization codes.

TFRI information 1741 represents a channelization code used for HS-PDSCH, an MCS level, and values applied to HS-PDSCH by the rate matcher 1733. A UE can correctly analyze HS-PDSCH by receiving the TFRI information. HARQ information 1742 informs a UE whether a packet transmitted over HS-PDSCH is an initially transmitted packet or a retransmitted packet for a particular channel. Based on the HARQ information, the UE can analyze a property of a packet currently received over HS-PDSCH and use the result for a proper purpose. For example, the proper purpose refers to combining a retransmitted packet with a previously received defective packet thereby to restore the defective packet.

The TFRI information 1741 and the HARQ information 1742 encoded by encoders 1743 and 1744, respectively, and then provided to a multiplexer 1745. The TFRI information 1741 and the HARQ information 1742 can be transmitted in the form of simple information, transmitted in a separate encoding method in order to increase reliability, or repeatedly transmitted. The multiplexer 1745 configures HS-SCCH by receiving outputs of the encoders 1743 and 1744. A signal output from the multiplexer 1745 is spread with a channelization code for HS-SCCH by a spreader 1746, multiplied by a channel gain for HS-SCCH by a multiplier 1747, and then summed with other downlink channels by the summer 1760.

The summer 1760 sums the DL_DPCH, HS-PDSCH, HS-SCCH, undepicted channels for other users, and undepicted downlink common channels for transmitting control signals of the Node B. Since the downlink channels are multiplied by different channelizaton codes for identification, a UE receiving the downlink channels can properly analyze only the signals transmitted to the UE itself. Signals output from the summer 1760 are scrambled with a scrambling code used for the Node B by a multiplier 1761, and then modulated by a modulator 1762. The modulated signals are up-converted into carrier band signals by an RF processor 1763, and then transmitted to a UE through an antenna 1764. The scrambling code used in the multiplier 1761 is used for identification of downlink signals from Node Bs or cells.

As described above, the present invention assigns different pilot symbol offsets to UEs located in a soft handover region so that a Node B can prevent interference among uplink dedicated physical control channels transmitted from the UEs located in the soft handover region. As a result, the Node B can efficiently control transmission power of the uplink dedicated physical control channels from the UEs located in the soft handover region.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting a control channel having an acknowledgement/negative acknowledgement (ACK/NACK) information field indicating whether packet data is received at a Node B from a particular user element (UE) when the particular UE moves from the Node B to a handover region shared by the Node B and a neighbor Node B during reception of high speed packet data from the Node B, a channel quality information (CQI) field indicating a condition of a channel over which the high speed packet data is transmitted, and a pilot signal field for power control, in a mobile communication system including the Node B, the particular UE located in an area occupied by the Node B, the neighbor Node B being adjacent to the Node B, and a radio network controller (RNC) connected to the Node B and the neighbor Node B, the method comprising the steps of:
identifying, by the RNC, a plurality of UEs including the particular UE, all of which are located in the handover region and receive the high speed packet data;
transmitting, by the RNC, pilot signal field position information to the particular UE;
including, by the particular UE, a pilot signal in a control channel at a position based on its own pilot signal field position information; and
transmitting, by the particular UE, the control channel.

2. The method of claim 1, wherein the RNC randomly determines the pilot signal field position information of the particular UE within the CQI field.

3. The method of claim 2, wherein the RNC transmits the pilot signal field position information to the Node B through a predetermined signaling message.

4. The method of claim 3, further comprising the step of transmitting to the Node B, by the RNC, an active time parameter indicating a time point where the particular UE transmits the control channel, upon receiving a channel resource reconfiguration complete report in response to the pilot signal field position information.

5. The method of claim 4, wherein the RNC transmits to the plurality of UEs the active time parameter along with the pilot signal field position information.

6. The method of claim 3, wherein the predetermined signaling message is a Node B application part (NBAP) message.

7. A mobile communication system including a Node B, a particular user element (UE) located in an area occupied by the Node B, a neighbor Node B being adjacent to the Node B, and a radio network controller (RNC) connected to the Node B and the neighbor Node B, for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control, the system comprising:
the Node B for identifying a plurality of UEs including the particular UE, all of which are located in the handover region and receive the high speed packet data, and transmitting pilot signal field position information;
the RNC for transmitting the pilot signal field position information to the particular UE; and
the particular UE for including a pilot signal in a control channel at a position based the pilot signal field position information, and transmitting the control channel.

8. The mobile communication system of claim 7, wherein the Node B transmits the pilot signal field position information to the RNC through a predetermined signaling message.

9. The mobile communication system of claim 8, wherein the Node B receives an active time parameter indicating a time point where the particular UE transmits the control channel, from the RNC in response to the pilot signal field position information.

10. The mobile communication system of claim 9, wherein the Node B receives the control channel, extracts the pilot signal field from the control channel at a position based on the pilot signal field position information, and generates a transmission power control command (HS-TPC) for power control on the control channel based on a pilot signal included in the pilot signal field.

11. The mobile communication system of claim 8, wherein the predetermined signaling message is a Node B application part (NBAP) message.

12. A transmission apparatus of a user element (UE) for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control, in a mobile communication system including the Node B, the particular UE located in an area occupied by the Node B, the neighbor Node B being adjacent to the Node B, and a radio network controller (RNC) connected to the Node B and the neighbor Node B, the transmission apparatus comprising:
a controller for generating and controlling a pilot signal to be transmitted over the pilot signal field;
a multiplexer for configuring the control channel by multiplexing ACK/NACK information to be transmitted over the ACK/NACK information field, CQI information to be transmitted over the CQI field, and the pilot signal; and
a pilot signal field position controller for controlling the multiplexer based on pilot signal field position information provided from the RNC.

13. A reception apparatus of a user element (UE) for transmitting a control channel having an acknowledgement/negative acknowledgement (ACK/NACK) information field indicating whether packet data is received at the Node B from the particular UE when the particular UE moves from the Node B to the handover region shared by the Node B and the neighbor Node B during reception of high speed packet data from the Node B, a channel quality information (CQI) field indicating a condition of a channel over which the high speed packet data is transmitted, and a pilot signal field for power control, in a mobile communication system including the Node B, the particular UE located in an area occupied by the Node B, the neighbor Node B being adjacent to the Node B, and a radio network controller (RNC) connected to the Node B and the neighbor Node B, the reception apparatus comprising:
a pilot signal field position controller for controlling a demultiplexer based on pilot signal field position information determined for the particular UE;
the demultiplexer for extracting the pilot signal field from the control channel under the control of the pilot signal field position controller; and
a controller for generating a transmission power control command (HS-TPC) for power control on the control channel based on a pilot signal included in the pilot signal field.
